(19) United States
(12) Patent Application Publication
(10) Pub. No.: US 2026/0162481 A1
(43) Pub. Date: Jun. 11, 2026

(54) METHOD AND SYSTEM FOR AREA ACCESS USING DISTRIBUTED KEYS

(71) Applicant: Capital One Services, LLC, McLean, VA (US)

(72) Inventors: Kevin Osborn, Newton Highlands, MA (US); David Kelly Wurmfeld, Melbourne, FL (US); Renee Gill, New York, NY (US)

(73) Assignee: Capital One Services, LLC, McLean, VA (US)

(21) Appl. No.: 18/969,567

(22) Filed: Dec. 5, 2024

(51) Int. Cl. G07C 9/00

(52) U.S. Cl. CPC G07C 9/00912

(57) ABSTRACT

Embodiments are directed to systems and techniques to control area access for secure areas, such as bank vaults, teller drawers, and lobbies, with distributed keys generated by contactless cards.

### BACKGROUND

In many business and personal environments, accessing certain areas such as vaults, safes, rooms, lockers, and various other secure areas requires one or more physical keys to unlock a locking mechanism proximate the area to enter. This is meant to secure objects and tangible things within the secure area from being stolen or otherwise accessed. In one example, a bank vault is typically secured by a locking system that requires multiple keys to be inserted into separate locks to unlock the vault. In this example, one person is given one key and a second person is given a second key and both keys must be inserted into separate locks, and both locks must be unlocked in order for the vault to be opened. Similar requirements may be in place for personal home safes, safe rooms, secure closets, and various other secure systems with physical security in place. Unfortunately, there are many disadvantages to this security design. For example, if a key is lost or damaged and only one remains, or if the lock itself breaks, the dual key requirement is not met and the secure area cannot be accessed by authorized personnel.

Accordingly, there is a need to provide businesses and the public at large with an appropriate solution that overcomes current deficiencies to provide data security, authentication, and verification for a contactless card.

### BRIEF SUMMARY

One general aspect of the present disclosure includes a method for area access using distributed keys. The method includes receiving, at an authentication server, first encrypted data from a first contactless card associated with a first user account and second encrypted data from a second contactless card associated with a second user account. The method further includes determining, by the authentication server and based on the first encrypted data and the second encrypted data, whether the first user account and the second user account are authorized to alter a state of an access control system. The method further includes in response to both the first user account and the second user account being authorized, causing, by the authentication server, a signal to be sent to the access control system to alter the state thereof.

Another general aspect of the present disclosure includes an access control system for area access using distributed keys. In some embodiments, the access control system includes a locking mechanism to prevent physical access to an area, a memory for storing executable instructions, and a processing circuit in communication with the locking mechanism, the processing circuit to execute the executable instructions, which when executed cause the processing circuit to perform various functions. For example, after executing the instructions, the processing circuit is to receive first encrypted data associated with a first user account and second encrypted data associated with a second user account. The processing circuit is further to send the first encrypted data and the second encrypted data to an authentication server to determine whether the first user account and the second user account are authorized to alter a state of the locking mechanism. The processing circuit is further to, in response to receiving, from the authentication server, an indication that the first user account and the second user account are authorized, send a control signal to the locking mechanism to alter the state thereof to thereby allow or prevent access to the area.

Another general aspect of the present disclosure includes a non-transitory computer-readable storage medium having executable instructions stored thereon, which, when executed by a processing circuit of an authentication server, cause the processing circuit to receive first encrypted data from a first contactless card associated with a first user account and second encrypted data from a second contactless card associated with a second user account. Execution of the executable instructions further causes the processing circuit to determine, based on the first encrypted data and the second encrypted data, whether the first user account and the second user account are authorized to access a controlled area. Execution of the instructions further causes the processing circuit to, in response to both the first user account and the second user account being authorized, cause a signal to be sent to an access control system to alter a state thereof to grant or prevent access to the controlled area.

Non-transitory computer program products (i.e., physically embodied computer program products) are also described that store instructions, which, when executed by one or more data processors (i.e., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

FIG. 1 is a block diagram of an access control network of the subject matter in accordance with one embodiment.

FIG. 2 is a block diagram of an authentication environment of the subject matter in accordance with one embodiment.

FIG. 3 is a block diagram illustrating another embodiment of an access control network in accordance with one embodiment.

FIG. 4 is a block diagram illustrating another embodiment of an access control network in accordance with one embodiment.

FIG. 5 is a diagram illustrating an example contactless card in accordance with one embodiment.

FIG. 6 is a block diagram illustrating components of an example contactless card in accordance with one embodiment.

FIG. 7 illustrates a flow chart of a method in accordance with one embodiment.

FIG. 8 illustrates a sequence flow in accordance with one embodiment.

FIG. 9 is a network diagram of an example routing network in accordance with embodiments discussed herein.

FIG. 10A illustrates a sequence flow in accordance with one embodiment.

FIG. 10B illustrates a sequence flow in accordance with one embodiment.

FIG. 10C illustrates a sequence flow in accordance with one embodiment.

FIG. 11 is a format diagram of a message in accordance with one embodiment.

FIG. 12 is a block diagram of a key system according to an example embodiment.

FIG. 13 is a flow diagram of a routine in accordance with one embodiment.

FIG. 14 is a network diagram of a distributed network in accordance with one embodiment.

FIG. 15 illustrates a flow diagram of a method in accordance with one embodiment.

### DETAILED DESCRIPTION

Described herein is one example solution to the above deficiencies of the existing secure area security system landscape using contactless card products. Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. However, in addition to making purchases, contactless cards can also be used to verify an identity of the person using the contactless card.

Described herein are embodiments of a method, system, and computer readable storage medium for accessing or controlling access to a secure area using distributed keys. Distributed keys refers to parts of an access key (e.g., passkey or authorization code) to access a controlled or secure area being provided by one contactless card and another part of the access key being provided by a second contactless card. When the parts of the access key are combined, the combination can be verified and the verified access key permits access to the secured area.

As described above, an example locking system that provides and denies access to a secured area includes a locking system for a bank vault. Although the examples described herein relate to a bank vault, other security systems are also contemplated such as, a safe, storage room, a branch access door, a teller's drawer, a closet, or any other suitable area for which security of the area is desired. As described above, in existing systems, the locking system for the bank vault may include two locks, each having a different key that unlocks the vault. Once both keys are inserted and activated, both locks unlock and grant access to within the vault to those operating the lock. In embodiments of the present disclosure, instead of locks, the vault or access control system, includes one or more contactless card readers. One employee of the bank is assigned a first portion of the combination key and a second employee of the bank is assigned a second portion of the combination key. The employees bring their contactless cards within a proximity of the one or more contactless card readers (e.g., sequentially or simultaneously). The contactless cards send, through the one or more contactless card readers, authentication codes to an authorization server to verify an identity of the user accounts associated with each card.

Once the user accounts associated with each contactless card are verified by the authorization server, the combination of the keys is verified and a control signal is sent to a locking mechanism of the vault. The control signal causes the locking mechanism to transition states from locked to unlocked or from unlocked to lock. That is, the methods and systems described herein can be used to provide access (i.e., unlock) to the secured area (e.g., the vault), or to prevent access (i.e., lock) to the secured area. Additionally, the methods and systems described herein can be used to access secured devices such as data entry terminals (e.g., keyboards, movement based user interfaces such as track pads or mice, etc.), monitors, and the like.

Other variations on this general description are also contemplated. In some instances, contactless card functions discussed herein may be utilized in a multi-issuer computing environment. These functions may include tap-to functions where a user may tap their contactless card on a device, such as a contactless card reader or a mobile device, to perform a function. For example, a user may utilize their contactless card to verify their identify and obtain access to a secure area, perform a payment, launch applications, login into applications, autofill a form or field, navigate to a specified web location or app on a device, unlock a door, unlock a safe, unlock a teller drawers, initiate a contactless card, verify themselves, and so forth. As discussed above, the functions described herein are not only for employees at banks or other enterprises. They can also be provided to individual customers to provide robust security to other secure spaces such as home safes, safe rooms, and other secure areas.

The systems and methods described herein may enable users to perform these functions in a multi-issuer environment. Further, the systems discussed herein enable card issuers or payment providers, such as a banks, to issue contactless cards with tap-to functions to customers while maintaining a high-level security. The systems discussed differ from previous solutions because they provide a single platform for multiple issuers to provide the tap-to functionality. Traditionally, each issuer must set up and maintain their own systems to provide contactless card features. This includes maintaining their own hardware, software, databases, security protocols, and so forth, which can become extremely costly for the issuer to maintain. However, embodiments discussed enable issuers to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that another issuer cannot access another issuer's data or functions. As will be discussed in more detail, these features may be provided by a switchboard system that is configured to process and perform each contactless card function in a secure manner. Additional benefits for issuers may include providing a highly secure authentication option for mobile web, which typically lack the robust authentication options available in a native application.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and JavaScript® Software Development Kit (SDK) with WebNFC®. For iOS®, embodiments include providing a tap-to software development kit including functions and services to perform the operations discussed herein on the iOS®platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC communications between the mobile device contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and UIs libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

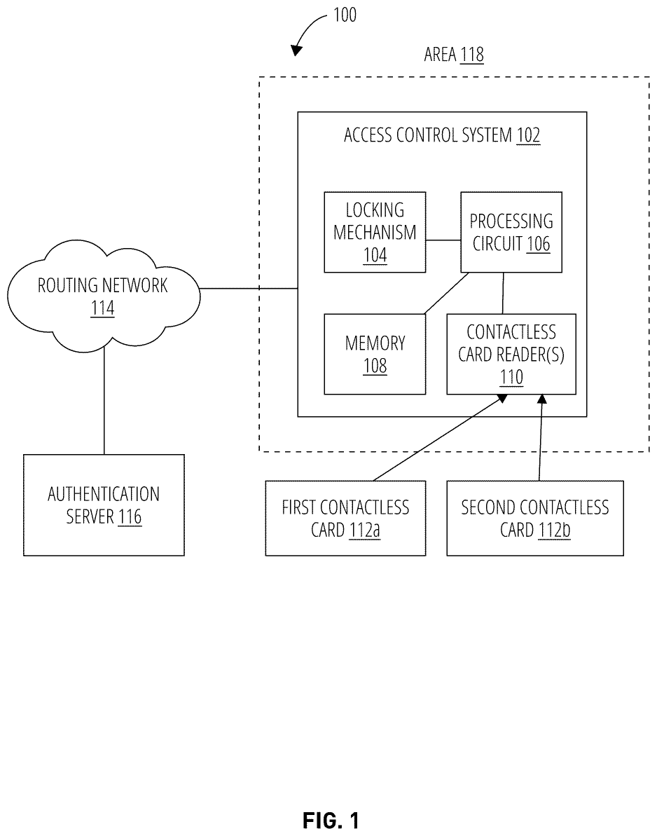

FIG. 1 illustrates an access control network 100 according to some embodiments of the present disclosure. As described above, there is an area 118 that can include one or more of: a bank vault, safe, room, closet, branch (or any other business) room or lobby, teller drawer, or any other suitable area whose access is controlled by access control system 102. The access control system 102 can be located on a door of the area 118, on a wall beside a door to the area 118, or any other suitable location. In some embodiments, the access control system 102 includes a locking mechanism 104, processing circuit 106, memory 108, and one or more contactless card reader(s) 110.

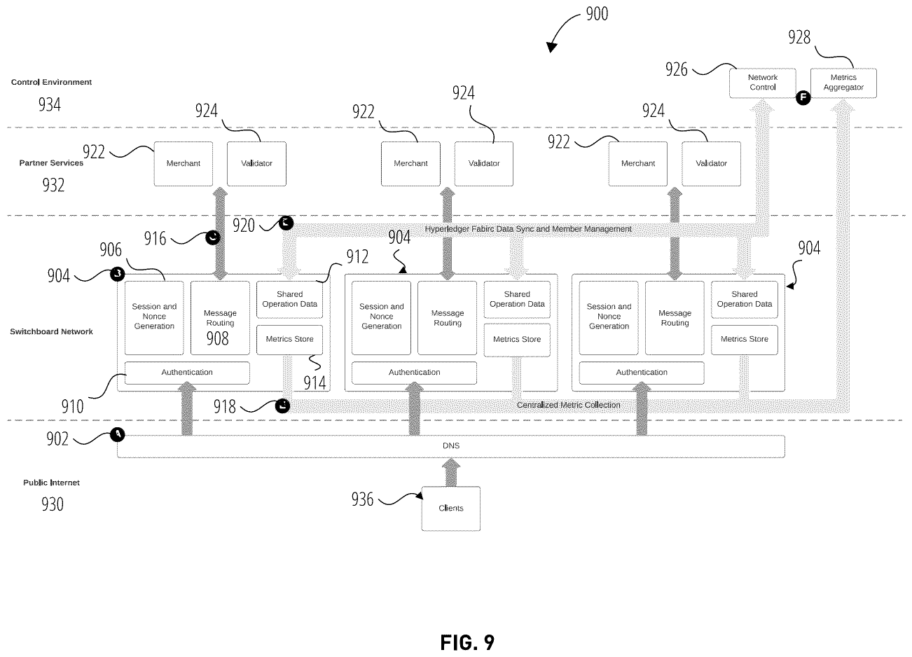

In some embodiments, the access control system 102 can be network connected via a Local Area Network (LAN), Wide Area Network (WAN), mobile communications network (i.e., 2G, 3G, 4G, LTE, 5G, 6G, etc.), the Internet, Wireless LAN, or any other suitable network. The access control system 102 can be connected to a routing network 114, and through the routing network 114, the access control system 102 can be connected to an authentication server 116. An example of a routing network 114 is described with respect to FIG. 9. The routing network 114 aids the system described herein in communicating the encrypted data from the contactless cards to the authentication server 116 to be verified.

In some embodiments, the contactless card reader(s) 110 can receive encrypted data to verify an identity of a user account associated with first contactless card 112a and a user account associated with second contactless card 112b. The contactless card reader(s) 110 can communicate with first contactless card 112a and second contactless card 112b to receive the encrypted data via BlueTooth®, wireless fidelity (WiFi), radio frequency identification (RFID), near field communication (NFC), or any other suitable communication method.

In some embodiments, the authentication server 116 is located in a different location than the area 118, and the access control system 102 is to communicate with the authentication server 116 via the routing network 114. However, in other embodiments, the access control system 102 includes the authentication server 116 on site, and the routing network 114 may not be needed. For example, the authentication server 116 and the access control system 102 can be located on the same network and at the same physical location, and therefore no routing would be necessary.

As discussed above, in some embodiments, an access control system 102 can include a locking mechanism 104 to prevent physical access to an area 118. The locking mechanism 104 can include any suitable electromechanical system that has a lock that can prevent access to the area 118. Any suitable bank vault locking system, safe locking system, door locking system, teller drawer locking system, or any other locking system is contemplated by the present disclosure as acting as the locking mechanism 104. In some embodiments, the locking mechanism 104 can include a processor (not shown) and other control circuitry that can receive a signal (e.g., control signal) from the processing circuit 106 of the access control system 102 or any other processing circuitry to alter a state of the locking mechanism 104. For example, a control signal can be sent from processing circuit 106 to the processor of the locking mechanism 104 to alter the state of the locking mechanism 104, such as by changing a lock from an unlocked state to a locked state, or by changing from an unlocked state to a locked state. The lock can be controlled by a controller (e.g., the process) and can be a mechanical device operated or actuated by a motor, solenoid, or any other suitable control member. When the controller or processor of the locking mechanism 104 receives a control signal, it causes the motor or solenoid to activate and the lock of the locking mechanism 104 changes state.

In some embodiments, the access control system 102 includes memory 108 for storing executable instructions thereon. The instructions, when executed by a processing circuit 106 of the access control system 102, causes the processing circuit 106 to perform various functions discussed below. As described above, the processing circuit 106 is in communication with the locking mechanism 104 and can send control signals thereto. Other devices and processing circuits outside of the access control system 102 can also be in communication with the locking mechanism 104 to send control signals to the locking mechanism 104. For example, instead of the processing circuit 106 of the access control system 102 sending a control signal to the locking mechanism 104 to alter the state thereof, an outside controller or processing circuit (e.g., the authentication server 116) can send a communication to the locking mechanism 104 to alter the state thereof. However, the present disclosure assumes the processing circuit 106 will send the control signal to the locking mechanism 104 to alter the state thereof.

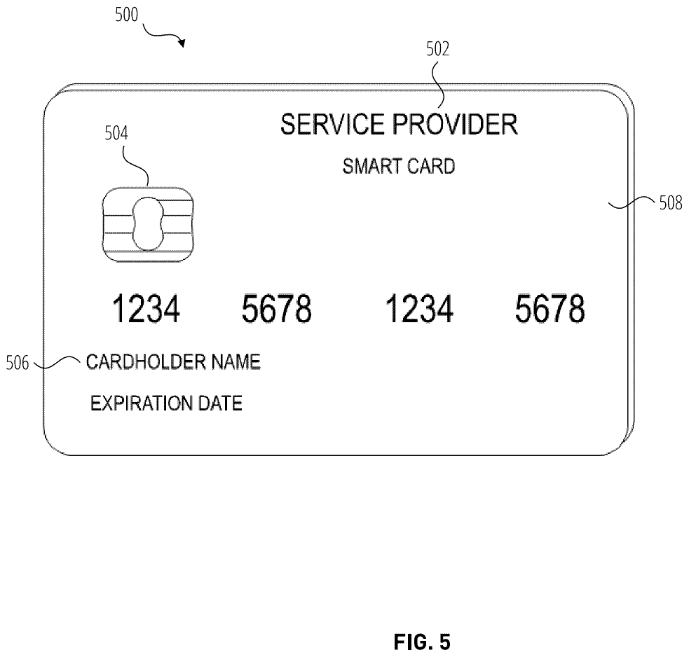

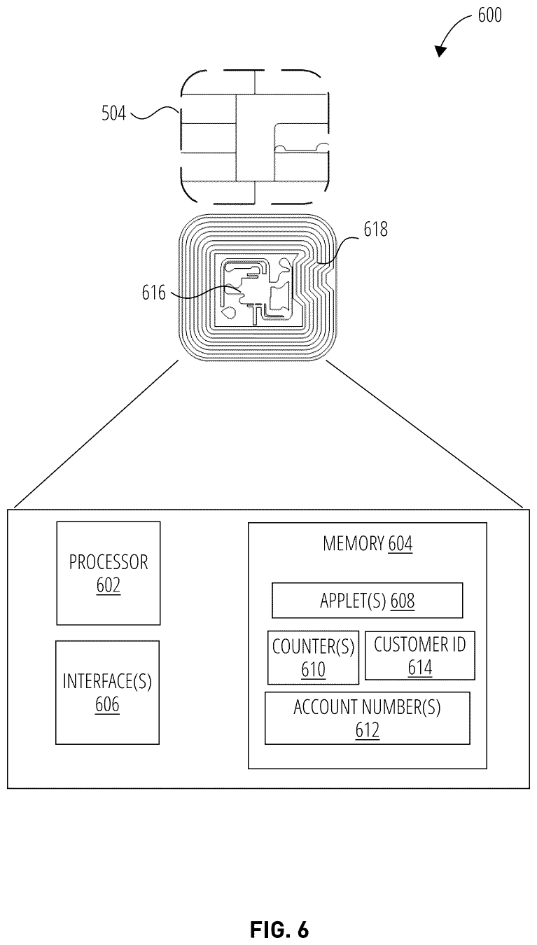

As discussed above, the processing circuit 106 is to execute the executable instructions in the memory 108, which when executed cause the processing circuit 106 to receive first encrypted data associated with a first user account and second encrypted data associated with a second user account. In some embodiments, the first encrypted data and the second encrypted data can be received from first contactless card 112a and second contactless card 112b, respectively. The encrypted data can be received from the first contactless card 112a and second contactless card 112b via the contactless card reader(s) 110 via NFC, RFID, WiFi, BlueTooth or any other suitable means. An example contactless card is described in FIG. 5 and FIG. 6.

The access control system 102 can indicate to users, via the contactless card reader(s) 110, that the access control system 102 is ready to receive the encrypted data from the first contactless card 112a and second contactless card 112b. For example, light emitting diodes (LEDs) (not shown) can be included on the contactless card reader(s) 110 to indicate when the access control system 102 is prepared to receive the encrypted data. Alternatively, the encrypted data may only be receivable during certain times of the day, such as at the beginning or end of a work or banking day. In any event, the contactless card reader(s) 110 will receive and accept the encrypted data from the first contactless card 112a and second contactless card 112b as described herein.

In some embodiments, a user with first contactless card 112a will tap their card or bring it within a defined proximity to the contactless card reader(s) 110, sending the first encrypted data in the process, and then the user with the second contactless card 112b will tap their card or bring it within a defined proximity to the contactless card reader(s) 110, sending the second encrypted data in the process. In some embodiments, the first contactless card 112a and the second contactless card 112b are tapped to the contactless card reader(s) 110 sequentially and in other embodiments, the cards are tapped simultaneously. In either event, the first encrypted data and second encrypted data received from the cards is received by the processing circuit 106 and then forwarded to the authentication server 116.

The encrypted data can include any suitable data, such as an authentication code, meant for verifying the identity of the user account associated with the respective contactless card. For example, the authentication codes can be unique authentication codes, one for each corresponding contactless card. The encrypted data can include the authentication code and any other suitable data needed for verifying the identity of the user or user account of the contactless card.

Once the first encrypted data from the first contactless card 112a and the second encrypted data from the second contactless card 112b are received, the access control system 102, via the processing circuit 106, is to send the first encrypted data and the second encrypted data through the routing network 114 and eventually to an authentication server 116 to determine whether the first user account (i.e., associated with the first contactless card 112a) and the second user account (i.e., associated with the second contactless card 112b) are authorized to alter a state of the locking mechanism. As described below, both the first encrypted data associated with the first user account and the second encrypted data associated with the second user account will need to be verified before the state of the locking mechanism 104 can be altered.

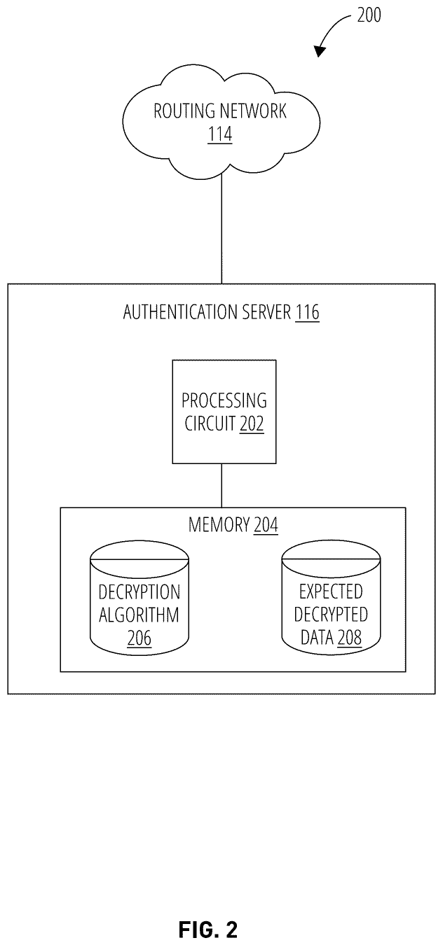

As discussed in greater detail with respect to FIG. 2, the authentication server 116 will receive, through the routing network 114, the first encrypted data and the second encrypted data from the access control system 102 and then process the encrypted data to verify the identity of the user accounts of the respective contactless cards and either authorize or not authorize the user accounts to alter the state of the locking mechanism 104. In response to receiving, from the authentication server 116, an indication that the first user account and the second user account are authorized to alter the state of the locking mechanism 104, the processing circuit 106 is to send a control signal to the locking mechanism 104 to alter the state thereof to thereby allow or prevent access to the area 118. On the other hand, if the authentication server 116 is unable to verify the identity of the first user account and the second user account, no control signal is sent to alter the state of the locking mechanism 104 and access to the area 118 is not provided. As discussed above, altering the state of the locking mechanism 104 includes both locking and unlocking the locking mechanism 104, so the control signals above can also cause the locking mechanism 104 to transition to a locked state as well to lock the vault at the end of the day.

Once the authentication server 116 verifies the identity of the first user account and the second user account, the authentication server 116 sends the indication to the processing circuit 106 that both of the user accounts are authorized to alter the state of the locking mechanism 104. The processing circuit 106 then sends the control signal to the 104 to alter the state thereof. The indication from the authentication server 116 can include a first portion of a Shannon-Secret-Sharing key and a second portion of the Shannon-Secret-Sharing key. The Shannon-Secret-Sharing key is the combination key described above. The authentication server 116 sends the first portion of the Shannon-Secret-Sharing key and the second portion of the Shannon-Secret-Sharing key to the processing circuit 106 of the access control system 102. The processing circuit 106 is then to combine the first portion of the Shannon-Secret-Sharing key and the second portion of the Shannon-Secret-Sharing key to obtain a combined Shannon-Secret-Sharing key. Then the processing circuit 106 is to compare the combined Shannon-Secret-Sharing key to an expected Shannon-Secret-Sharing key. In response to the combined Shannon-Secret-Sharing key corresponding to the expected Shannon-Secret-Sharing key, the processing circuit 106 is to send the control signal to the locking mechanism 104 to alter the state thereof.

FIG. 2 illustrates an authentication environment 200 that includes that routing network 114 and the authentication server 116 from FIG. 1. As shown in FIG. 2, the authentication server 116 may include a processing circuit 202 coupled to memory 204. In some embodiments, the memory 204 includes a decryption algorithm 206 for the processing circuit 202 to execute and expected decrypted data 208 to compare the decrypted data to in order to determine whether the first user account and second user account from FIG. 1 are authorized to alter the state of the locking mechanism 104 from FIG. 1.

In some embodiments, once the authentication server 116 receives the first encrypted data from the first contactless card 112a and the second encrypted data from the second contactless card 112b, the authentication server 116 is to decrypt the encrypted data to verify the identity of the first user account and the second user account. The authentication server 116 is to derive (for example, using a counter included in the first encrypted data) a first decryption key to decrypt the first encrypted data. The authentication server 116 is further to derive (for example, using a counter included in the first encrypted data) a second decryption key to decrypt the second encrypted data. Once the first encrypted data and second encrypted data are decrypted, using the first and second decryption keys, the authentication server 116 compares the decrypted data to expected decrypted data 208 stored in memory 204.

For example, in some embodiments, the authentication server 116 is to compare the first decrypted data corresponding to the first encrypted data from the first contactless card 112a and the second decrypted data corresponding to the second encrypted data from the second contactless card 112b, to a list of authorized user accounts that are authorized to alter a state of the locking mechanism 104. The authentication server 116 is then to determine whether the first decrypted data matches a corresponding first expected decrypted data for the first user account and whether the second decrypted data matches a corresponding second expected decrypted data for the second user account. In response to both the first decrypted data matching and the second decrypted data matching, the authentication server 116 is to send the first portion of the Shannon-Secret-Sharing key and the second portion of the Shannon-Secret-Sharing key to the access control system 102.

If, however, either of the first decrypted data or the second decrypted data does not match their respective expected decrypted data, the authentication server 116 does not send a portion of the Shannon-Secret-Sharing key to the 102. If both portions of the Shannon-Secret-Sharing key is not received by the access control system 102, the state of the locking mechanism 104 will not be altered.

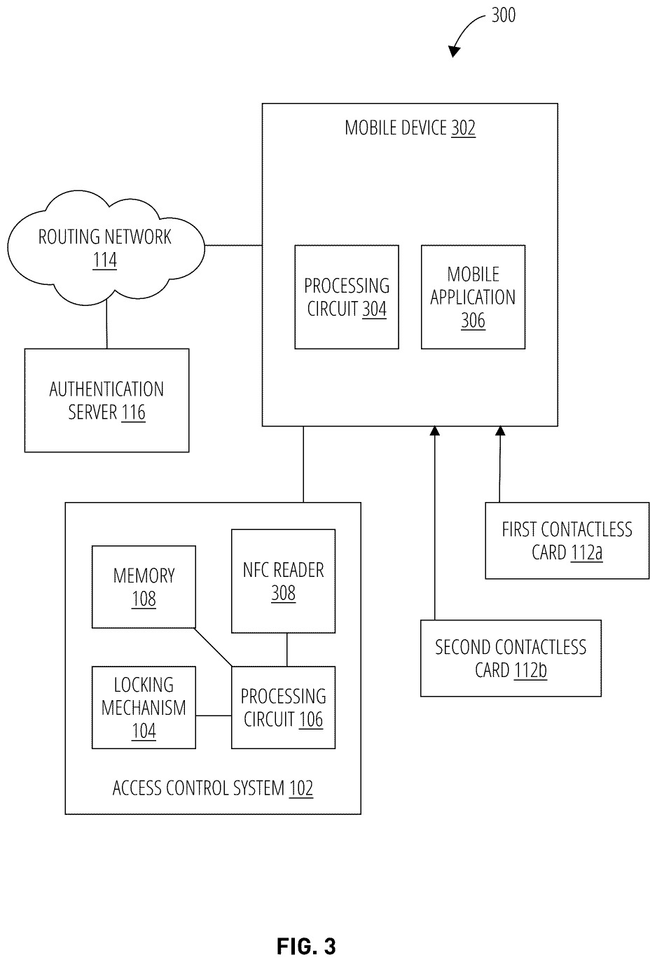

FIG. 3 illustrates an offline scenario 300 whereby the access control system 102 is not able to connect to the authentication server 116 to perform the authentication of the first user account and the second user account. For example, in some embodiments, the Internet might be out, preventing the access control system 102 from being able to communicate through the routing network 114 to the authentication server 116. In such embodiments, a mobile device 302 may be provided to facilitate the communication.

For example, one or more mobile devices 302 may be provided (e.g., the user of first contactless card 112a uses their mobile device and the user of second contactless card 112b uses their mobile device) with a processing circuit 304 and mobile application 306 operating thereon. The processing circuit 304 may execute the mobile application 306 which causes the mobile device 302 to receive the encrypted data via RFID, NFC, BlueTooth®, WiFi, or any other suitable manner. The mobile device 302 then receives the first encrypted data from first contactless card 112a and the second encrypted data from second contactless card 112b and the mobile device 302 then forwards the encrypted data over the routing network 114 to the authentication server 116. The same decryption described in FIG. 2 above is performed. However, instead of the authentication server 116 sending the first portion of the Shannon-Secret-Sharing key and the second Shannon-Secret-Sharing key directly to the access control system 102, the authentication server 116 sends the first and second Shannon-Secret-Sharing keys to the mobile device 302.

In some embodiments, the mobile application 306 not only allows the mobile device 302 to receive the encrypted data from the first contactless card 112a and the second contactless card 112b. The mobile application 306 is also to allow the mobile device 302 to transfer the Shannon-Secret-Sharing key portions to the access control system 102 via NFC reader 308. For example, once the mobile device 302 receives the Shannon-Secret-Sharing key portions, the mobile device 302 can send the Shannon-Secret-Sharing key portions to the access control system 102 via NFC reader 308 and the processing circuit 106 of the access control system 102 can receive the Shannon-Secret-Sharing key portions from the NFC reader 308. This transfer does not require the access control system 102 to have an internet connection, and therefore, even if the access control system 102 is not connected to the authentication server 116 via a network, the Shannon-Secret-Sharing key portions can still get to the access control system 102. Once the Shannon-Secret-Sharing key portions are obtained by the processing circuit 106, they are combined and the combination is verified against an expected Shannon-Secret-Sharing key. If the combination matches the expected Shannon-Secret-Sharing key, the processing circuit 106 sends the control signal to the locking mechanism 104 to alter the state thereof.

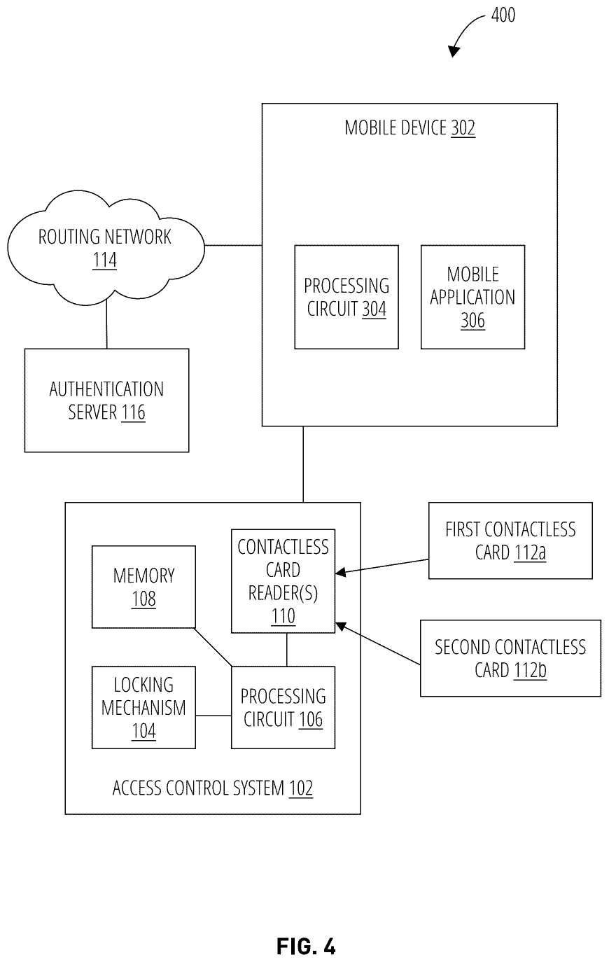

FIG. 4 illustrates another example offline scenario 400, whereby the mobile device 302 no longer receives the first encrypted data and the second encrypted data from the first contactless card 112a and the second contactless card 112b. In some embodiments where the access control system 102 is not connected to the authentication server 116 via a network, the access control system 102 and first contactless card 112a and second contactless card 112b are configured to operate using public key cryptography. In such a method, the first contactless card 112a and the second contactless card 112b each have their own unique private encrypted data assigned and stored thereon. They also each have their own corresponding public key that is shared with other devices, such as the access control system 102, and it is used to decrypt the private encrypted data. For example, the first contactless card 112a can share a first public key with the access control system 102 via contactless card reader(s) 110 and second contactless card 112b can share a second public key with the access control system 102 via contactless card reader(s) 110. The first public key will be used by the processing circuit 106 to decrypt the first encrypted data from the first contactless card 112a and the second public key will be used by the processing circuit 106 to decrypt the second encrypted data from the second contactless card 112b.

In this example embodiment, after the public keys have already been shared with the access control system 102, and the users of the first contactless card 112a and second contactless card 112b attempt to access the area 118, the access control system 102 will send a nonce to both the first contactless card 112a and the second contactless card 112b to trigger the cards to send their respective encrypted data. The first contactless card 112a will send first encrypted data to the access control system 102 in response to the nonce and the second contactless card 112b will send second encrypted data to the access control system 102 in response to the nonce. Upon receipt of the first and second encrypted data, the processing circuit 106 will use the first public key to decrypt the first encrypted data and the second public key to decrypt the second encrypted data. Like the authentication server 116 above, the processing circuit 106 of the access control system 102 will then compare the decrypted data from the first contactless card 112a and the second contactless card 112b and to expected data for the first contactless card 112a and the second contactless card 112b (or the user accounts associated therewith), and determine if the decrypted data matches the expected data. If so, the locking mechanism 104 will unlock or lock, depending on its current state, and allow the users access to the area 118.

In an alternative embodiment, instead of the Shannon-Secret-Sharing key from FIG. 3 being sent directly to the access control system 102, the mobile device 302 could send the first Shannon-Secret-Sharing key to the first contactless card 112a for storing in memory thereon, and send the second Shannon-Secret-Sharing key to the second contactless card 112b. When the users of the first contactless card 112a and the second contactless card 112b bring the cards in proximity to the contactless card reader(s) 110, the first Shannon-Secret-Sharing key and the second Shannon-Secret-Sharing key can be sent to the access control system 102. The Shannon-Secret-Sharing keys can be sent as is, without being encrypted first, or when the first contactless card 112a and the second contactless card 112b receive the Shannon-Secret-Sharing keys can be encrypted by their respective cards using a private key. The access control system 102 can be receive encrypted first Shannon-Secret-Sharing key and second Shannon-Secret-Sharing key and decrypt both using the first public key and second public key, respectively.

Any functionality discussed above that the first contactless card 112a or second contactless card 112b perform can also be performed by a computing device, such as mobile device 302. For example, instead of the contactless cards exchanging encrypted data and public and private keys with the access control system 102 and the authentication server 116, a mobile device (e.g., mobile device 302), such as a cell phone, mobile phone, smart phone, tablet computer, or any other suitable device can be used to transfer the encrypted data and public and secret keys discussed above. The mobile devices would be associated with the user accounts discussed above, just as the first contactless card 112a and second contactless card 112b are described herein. The mobile device 302 can share the keys and data with the access control system 102 via BlueTooth®, WiFi, RFID, NFC, or any other suitable communication protocol.

FIG. 5 illustrates an example configuration of a contactless card 500, which may include a contactless card, a payment card, such as a credit card, debit card, or gift card, issued by a service provider as displayed as a service provider indicia 502 on the front or back of the contactless card 500. In some cases, first contactless card 112a and second contactless card 112b can be embodied using contactless card 500. In some examples, the contactless card 500 is not related to a payment card, and may include, without limitation, an identification card. In some examples, the transaction card may include a dual interface contactless payment card, a rewards card, and so forth. The contactless card 500 may include a substrate 508, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 500 may have physical characteristics compliant with the ID-1 format of the ISO/IEC 7816 standard, and the transaction card may otherwise be compliant with the ISO/IEC 14443 standard. However, it is understood that the contactless card 500 according to the present disclosure may have different characteristics, and the present disclosure does not require a transaction card to be implemented in a payment card.

The contactless card 500 may also include identification information 506 displayed on the front and/or back of the card, and a contact pad 504. The contact pad 504 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 500 may also include processing circuitry, antenna and other components as will be further discussed in FIG. 6. These components may be located behind the contact pad 504 or elsewhere on the substrate 508, e.g. within a different layer of the substrate 508, and may electrically and physically coupled with the contact pad 504. The contactless card 500 may also include a magnetic strip or tape, which may be located on the back of the card (not shown in FIG. 5). The contactless card 500 may also include a Near-Field Communication (NFC) device coupled with an antenna capable of communicating via the NFC protocol. Embodiments are not limited in this manner.

FIG. 6 illustrates various circuitry of a transaction card component 600 of the contactless card 500. As illustrated in FIG. 6, the contact pad 504 of contactless card 500 may include processing circuitry 616 for storing, processing, and communicating information, including a processor 602, a memory 604, and one or more interface(s) 606. It is understood that the processing circuitry 616 may contain additional components, including processors, memories, error and parity/CRC checkers, data encoders, anticollision algorithms, controllers, command decoders, security primitives and tamperproofing hardware, as necessary to perform the functions described herein.

The memory 604 may be a read-only memory, write-once read-multiple memory or read/write memory, e.g., RAM, ROM, and EEPROM, and the contactless card 500 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 604 may be encrypted memory utilizing an encryption algorithm executed by the processor 602 to encrypt data.

The memory 604 may be configured to store one or more applet(s) 608, one or more counter(s) 610, a customer identifier 614, and the account number(s) 612, which may be virtual account number(s) 612 numbers. The one or more applet(s) 608 may comprise one or more software applications configured to execute on one or more contactless cards, such as a Java® Card applet. However, it is understood that applet(s) 608 are not limited to Java Card applets, and instead may be any software application operable on contactless cards or other devices having limited memory. The one or more counter(s) 610 may comprise a numeric counter sufficient to store an integer. The customer identifier 614 may comprise a unique alphanumeric identifier assigned to a user of the contactless card 500, and the identifier may distinguish the user of the contactless card from other contactless card users. In some examples, the customer identifier 614 may identify both a customer and an account assigned to that customer and may further identify the contactless card 500 associated with the customer's account. As stated, the account number(s) 612 may include thousands of one-time use virtual account numbers associated with the contactless card 500. An applet(s) 608 of the contactless card 500 may be configured to manage the account number(s) 612 (e.g., to select an account number(s) 612, mark the selected account number(s) 612 as used, and transmit the account number(s) 612 to a mobile device for autofilling by an autofilling service.

The processor 602 and memory 604 elements of the foregoing exemplary embodiments are described with reference to the contact pad 504, but the present disclosure is not limited thereto. It is understood that these elements may be implemented outside of the contact pad 504 or entirely separate from it, or as further elements in addition to processor 602 and memory 604 elements located within the contact pad 504.

In some examples, the contactless card 500 may comprise one or more antenna(s) 618. The one or more antenna(s) 618 may be placed within the contactless card 500 and around the processing circuitry 616 of the contact pad 504. For example, the one or more antenna(s) 618 may be integral with the processing circuitry 616 and the one or more antenna(s) 618 may be used with an external booster coil. As another example, the one or more antenna(s) 618 may be external to the contact pad 504 and the processing circuitry 616.

In an embodiment, the coil of contactless card 500 may act as the secondary of an air core transformer. The terminal may communicate with the contactless card 500 by cutting power or amplitude modulation. The contactless card 500 may infer the data transmitted from the terminal using the gaps in the contactless card's power connection, which may be functionally maintained through one or more capacitors. The contactless card 500 may communicate back by switching a load on the contactless card's coil or load modulation. Load modulation may be detected in the terminal's coil through interference. More generally, using the antenna(s) 618, processor 602, and/or the memory 604, the contactless card 500 provides a communications interface to communicate via NFC, Bluetooth, and/or Wi-Fi communications.

As explained above, contactless card 500 may be built on a software platform operable on smart cards or other devices having limited memory, such as JavaCard, and one or more or more applications or applets may be securely executed. Applet(s) 608 may be added to contactless cards to provide a one-time password (OTP) for multifactor authentication (MFA) in various mobile application-based use cases. Applet(s) 608 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 608 may be configured to encode the OTP as an NDEF type 4 well known type text tag. In some examples, NDEF messages may comprise one or more records. The applet(s) 608 may be configured to add one or more static tag records in addition to the OTP record.

In some examples, the one or more applet(s) 608 may be configured to emulate an RFID tag. The RFID tag may include one or more polymorphic tags. In some examples, each time the tag is read, different cryptographic data is presented that may indicate the authenticity of the contactless card. Based on the one or more applet(s) 608, an NFC read of the tag may be processed, the data may be transmitted to a server, such as a server of a banking system, and the data may be validated at the server.

In some examples, the contactless card 500 and authentication server 116 from FIG. 1 may include certain data such that the card may be properly identified. The contactless card 500 may include one or more unique identifiers (not pictured). Each time a read operation takes place, the counter(s) 610 may be configured to increment. In some examples, each time data from the contactless card 500 is read (e.g., by a mobile device), the counter(s) 610 is transmitted to the authentication server 116 for validation and determines whether the counter(s) 610 are equal (as part of the validation) to a counter of the authentication server 116.

The one or more counter(s) 610 may be configured to prevent a replay attack. For example, if a cryptogram has been obtained and replayed, that cryptogram is immediately rejected if the counter(s) 610 has been read or used or otherwise passed over. If the counter(s) 610 has not been used, it may be replayed. In some examples, the counter that is incremented on the card is different from the counter that is incremented for transactions. The contactless card 500 is unable to determine the application transaction counter(s) 610 since there is no communication between applet(s) 608 on the contactless card 500.

In some examples, the counter(s) 610 may get out of sync. In some examples, to account for accidental reads that initiate transactions, such as reading at an angle, the counter(s) 610 may increment but the application does not process the counter(s) 610. In some examples, when the contactless card reader(s) 110 is woken up, NFC may be enabled and the contactless card reader(s) 110 may be configured to read available tags, but no action is taken responsive to the reads.

To keep the counter(s) 610 in sync, an application, such as a background application, may be executed that would be configured to detect when the contactless card reader(s) 110 wakes up and synchronize with the server of a banking system indicating that a read that occurred due to detection to then move the counter(s) 610 forward. In other examples, Hashed One Time Password may be utilized such that a window of mis-synchronization may be accepted. For example, if within a threshold of 10, the counter(s) 610 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 610 increases in the appropriate sequence, then it is possible to know that the user has done so.

The key diversification technique described herein with reference to the counter(s) 610, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 500, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 500. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 500 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The encrypted data may be delivered as the content of a text NDEF record in hexadecimal ASCII format. In another example, the NDEF record may be encoded in base-ten ASCII format.

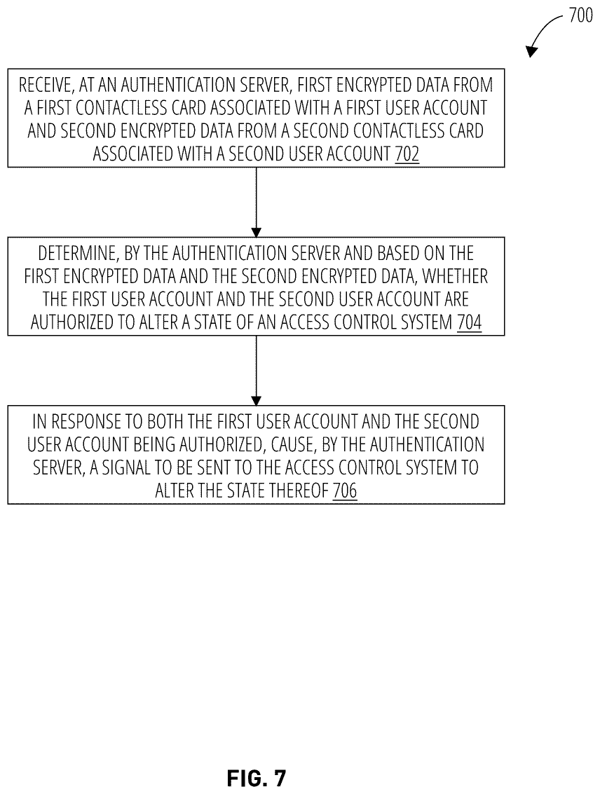

FIG. 7 illustrates a method 700 for area access using distributed keys according to some embodiments of the present disclosure. At block 702, method 700 receives, at an authentication server, first encrypted data from a first contactless card associated with a first user account and second encrypted data from a second contactless card associated with a second user account. In some embodiments, receiving the first encrypted data and the second encrypted data includes receiving, by the authentication server, the first encrypted data via a contactless card reader proximate to the access control system. At block 704, method 700 determines, by the authentication server and based on the first encrypted data and the second encrypted data, whether the first user account and the second user account are authorized to alter a state of an access control system. At block 706, method 700 in response to both the first user account and the second user account being authorized, causes, by the authentication server, a signal to be sent to the access control system to alter the state thereof. In some embodiments, altering the state of the access control system includes altering a locked state of a locking mechanism of one or more of the following: a bank vault, a branch access door, and a teller's drawer.

In some embodiments, the method 700 includes receiving the first encrypted data and the second encrypted data via a routing network connected between the authentication server and the contactless card reader, wherein the first encrypted data and the second encrypted data are received sequentially by the contactless card reader. In some embodiments, the method further comprises deriving, by the authentication server using a first counter included in the first encrypted data, a first decryption key to decrypt the first encrypted data and deriving, by the authentication server using a second counter included in the second encrypted data, a second decryption key to decrypt the second encrypted data. Once the first decryption key and second decryption key are derived, the method 700 includes decrypting, by the authentication server using, respectively, the first decryption key and second decryption key, the first encrypted data and the second encrypted data to obtain first decrypted data and second decrypted data, respectively. The method 700 further includes comparing, by the authentication server, the first decrypted data and second decrypted data to a list of authorized user accounts and corresponding expected decrypted data. The method 700 further includes determining, by the authentication server, that the first decrypted data matches a corresponding first expected decrypted data for the first user account and determining, by the authentication server, that the second decrypted data matches a corresponding second expected decrypted data for the second user account.

In some embodiments, the method 700 further includes in response to the authentication server determining that the first decrypted data matches the corresponding first expected decrypted data, sending a first portion of a Shannon-Secret-Sharing key to the access control system as part of the signal. The method 700 further includes in response to the authentication server determining that the second decrypted data matches the corresponding second expected decrypted data, sending a second portion of the Shannon-Secret-Sharing key to the access control system as part of the signal. In some embodiments, the first portion of the Shannon-Secret-Sharing key and the second portion of the Shannon-Secret-Sharing key are to be used by the access control system to alter the state thereof.

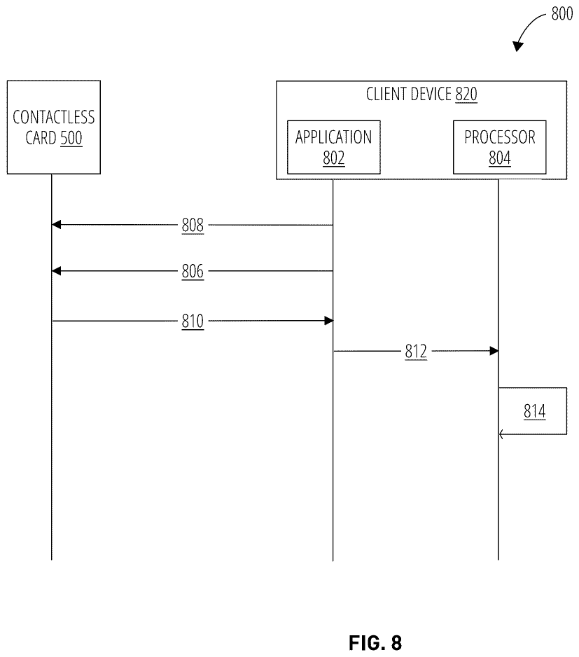

FIG. 8 is a timing diagram illustrating an example sequence for providing authenticated access according to one or more embodiments of the present disclosure. Sequence flow 800 may include contactless card 500, which is similar to first contactless card 112a and second contactless card 112b from FIG. 1, and client device 820, which can include the access control system 102 of FIG. 1 or mobile device 302 from FIG. 4, and may include an application 802 and processor 804.

At line 808, the application 802 communicates with the contactless card 500 (e.g., after being brought near the contactless card 500 and within communication range). Communication between the application 802 and the contactless card 500 may involve the contactless card 500 being sufficiently close to a card reader (such as contactless card reader(s) 110 from FIG. 1 or mobile device 302 from FIG. 3) of the client device 820 to enable NFC data transfer between the application 802 and the contactless card 500

At line 806, after communication has been established between client device 820 and contactless card 500, contactless card 500 generates a message authentication code (MAC) cryptogram or encrypted data (such as, for example, first encrypted data from the first contactless card 112a and the second encrypted data from the second contactless card 112b from FIG. 2 above). In some examples, this may occur when the contactless card 500 is read by the application 802. In particular, this may occur upon a read, such as an NFC read, of a near field data exchange (NDEF) tag, which may be created in accordance with the NFC Data Exchange Format. For example, a reader application, such as application 802, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 500 may be updated or incremented, which may be followed by “Read NDEF file.” At this point, the message may be generated, including a header and a shared secret. Session keys may then be generated. The MAC cryptogram or encrypted data may be created from the message, as discussed herein, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 802 may be configured to transmit a request to contactless card 500, the request comprising an instruction to generate a MAC cryptogram.

At line 810, the contactless card 500 sends the MAC cryptogram or encrypted data to the application 802. In some examples, the transmission of the MAC cryptogram occurs via NFC, however, the present disclosure is not limited thereto. In other examples, this communication may occur via Bluetooth, Wi-Fi, or other means of wireless data communication. At line 812, the application 802 communicates the MAC cryptogram to the processor 804.

At line 814, the processor 804 verifies the MAC cryptogram pursuant to an instruction from the application 122. For example, the MAC cryptogram or encrypted data may be verified, as explained herein. In some examples, verifying the MAC cryptogram may be performed by a device other than client device 820, such as a server of a banking system (e.g., authentication server 116) or authentication service of a switchboard system, in data communication with the client device 820. For example, processor 804 may output the MAC cryptogram for transmission to the banking system server, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

In some instances, embodiments may be implemented in a multi-issuer environment and messages are routed through a switchboard system, such as system 900. The switchboard system 900 is an example routing network 114 shown in FIGS. 1-4. FIG. 9 illustrates an example of system 900 in accordance with the embodiments discussed herein. The system 900 includes additional devices and systems configured to enable contactless card issuers to tap-to-card services. Specifically, system 900 enables any number of issuer systems to provide card services to their clients through a switching fabric, i.e., the switchboard system in a secure and safe manner.

In embodiments, the switchboard system includes one or more nodes 904 configured to perform routing operations. Each switchboard node 904 may include a session and nonce generator 906, a message router 908, an authentication 910, an operation data 912 store, and a metrics store 914. Further, each of the nodes may be configured the same and share configurations, but each switchboard node 904 may independently process and route messages and requests to the appropriate systems, such as the merchant systems and issuer systems. Each of the nodes 904 is configured to act as a broker of trust between an issuer system, a merchant system 922, and/or validation system 924, for example. Instead of a merchant system, the nodes 904 are configured to act as a broker of trust between the issuer system and a banking system, such as access control system 102 from FIG. 1. Each switchboard node 904 is configured to route each message to the correct issuer system while maintaining data security. For example, a switchboard node 904 may route a message between an issuer system and a merchant system while the node cannot access the private data in the message.

The switchboard system may be configured as a server system with a collection of hardware, software, and networking components that work together to provide client services. Hardware components may include one or more server computers, storage devices, and network adapters. The server computers are configured to run server applications, such as those executable on each of the nodes 904. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 904 may operate in a cloud-based computing environment, e.g., a collection of hardware, software, and networking components that enable the delivery of cloud computing services. The switchboard nodes 904 and the computing services are delivered over the Internet and can be accessed from anywhere in the world with an Internet connection. In embodiments, client 936 may access a switchboard node 904 through Domain Name System 902 or Domain Name System (DNS). The DNS 902 is a hierarchical and distributed naming system for computers, services, and other resources connected to the Internet or other networks. It associates various information with domain names assigned to each registered participant. In one example, the DNS 902 may translate a name known to software executing on a client 936 to route data to one or more of switchboard node 904 of the switchboard system. In embodiments, the DNS 902 may generate a number, such as an Internet Protocol (IP) address, an address record (A-record), or another Hostname (C-name record). At a high level, the Domain Name System 902 translates known domain names to numerical Internet Protocol (IP) addresses needed for locating and identifying computer services and devices with the underlying network protocols. Clients use the global DNS system to select the best node to use.

In one example, for a client to utilize DNS to resolve and communicate with one or more nodes of a switchboard system, such as the client 936, the DNS 902, and the switchboard node 904. Client 936 sends a request to a default DNS server for a text record switchboard. {domain}. {tld}. The text record may be preconfigured in a client app and/or client sdk. The DNS 902 returns one or more records. A DNS record structure may include the following:

• Root Record:

○ Name: switchboard.{domain}.{tld}
○ Type: TXT
○ Resolution:

▪ {nodename_1}.{operator_a}.{region_i}.switchboard.{domain}.{tld},
▪ {nodename_2}.{operator_a}.{region_i}.switchboard.{domain}.{tld},
▪ {nodename_1}.{operator_b}.{region_ii}.switchboard.{domain}.{tld},
▪ {nodename_2}.{operator_b}.{region_ii}.switchboard.{domain}.{tld},
▪ * etc.

○ Used For determining where there are active nodes

• Node Record:

○ Name: {nodename}.{operator}.{region}.switchboard.{domain}.{tld}
○ Type: A/AAAA or CNAME
○ Resolution: Actual node hostname or IP
○ Used For: communicating with a node 904

In embodiments, the client 936 may determine the current timezone. For example, the client app or sdk may utilize a get current timezone function, such as in JavaScript: Intl.DateTimeFormat( )resolvedOptions( )timeZone). Embodiments are not limited in this manner, and the app or sdk may determine the timezone via another/different function call. Further, the client 936 is configured to map the timezone to a region or short-version identifier of the region. One example includes America/New_York->na-e. The region may be based on DNS names, for example. Table 1 illustrates a few examples of timezone mappings to regions:

TABLE 1

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples; other timezone-to-region mappings may be utilized. Further and in embodiments, regions can also be represented as a bidirectional graph structure with the edges representing geographic neighbors. For example, na-e<->na-w and sa<->na-w and sa<->na-e. This representation is useful for node selection.

Further, the client 936 may identify or select a DNS record option previously returned that is in the region. If there are multiple matches, the client may select one at random. If there's no node available in a region, the client 936 may determine and use a data graph of neighboring regions to select a node in the closest region where a node is available. For example, sa has no node but is connected to na-e where there is a node and so na-e is selected.

Embodiments include the client 936 resolving a selected node's hostname. In embodiments, the client 936 automatically resolves the hostname using the client's HTTP request default resolver. Further, the Domain Name System 902 may return a result, and the client 936 may communicate with a switchboard node 904 and begin interacting with the switchboard.

In embodiments, a client 936 communicates with the switchboard system to perform one or more of the partner services 932, such as conducting a transaction with a merchant, validating the customer, or other tap-to functions. Once client 936 identifies a switchboard node 904 and resolves an address to communicate with switchboard node 904, client 936 may send one or more messages to switchboard node 904 to authenticate and perform the operation. The switchboard node 904 includes an authentication 910 function configured to authenticate the client 936. In embodiments, the client 936 sends a message or authorization request to the switchboard node 904 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 2 describes the value, name, and meaning:

TABLE 2

| Value | Name | Meaning |
|---|---|---|
| 65535 | Client | Individual |
| | ID | identifier of |
| | | client |
| GReyx5BuEAaE72bWbFZJfHRL8Dbt1Uum | Client | Randomly |
| | Key | assigned |
| | | key |

The switchboard node 904 may authorize or authenticate the client 936 or user, and the switchboard node 904 may utilize the additional components, such as the session and nonce session and node generator 906 and message router 908, to perform the operations. Note the Validators validation system 924 never interact with the merchant system 922, nor vice versa. The nodes node 904 brokers all communication. Again, the merchant system 922 shown in FIG. 9 can instead be a banking system, such as access control system 102 from FIG. 1.

In embodiments, the switchboard system may utilize a hyper ledger fabric 920 to manage and synchronize the shared operation data 912 and member management across the network. The hyperledger fabric 920 is distributed ledger framework having a permissioned network model that only authorized participants can join the network and access the data that is stored on a ledger.

In embodiments, the hyperledger fabric 920 may be generated by creating one or more sets of peers, an ordering service, and a channel. Once the network is created, system 900 deploys chaincode to the network, or node 904 is permitted to access the fabric. The chaincode is the code that runs on the blockchain and executes the network control 926 and operation data 912 logic code. Once the chaincode is deployed, each of the switchboard nodes 904 is configured to invoke transactions on the blockchain to add data to the blockchain, e.g., the operational data. A switchboard node 904 or another device can query the ledger to retrieve data. The ledger is a distributed database that stores all the data added to the blockchain.

All nodes 904 keep an independently verifiable log of their actions that can be transmitted to a centralized aggregator to build a picture of overall network usage. System 900 can manage network operation data and management at a central level and have a centralized view of network use, aggregated and abstracted to the appropriate level.

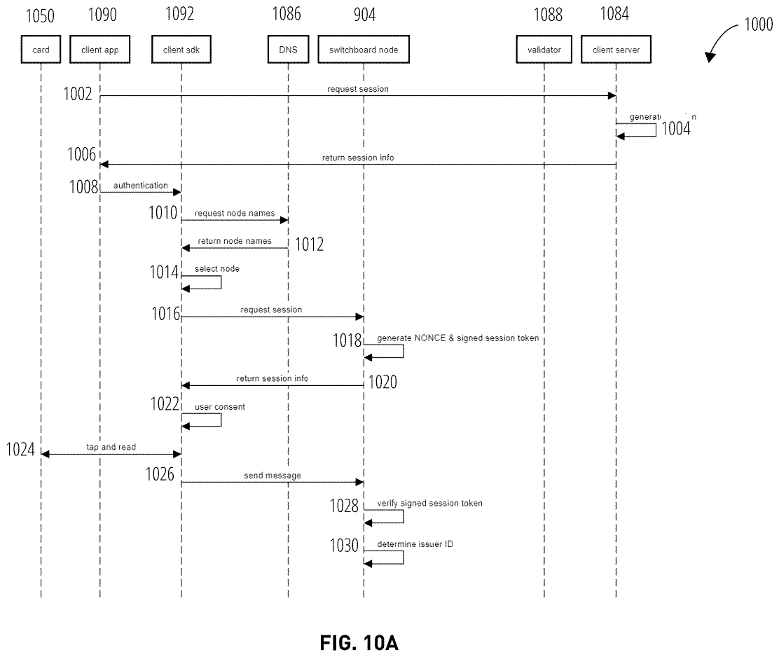

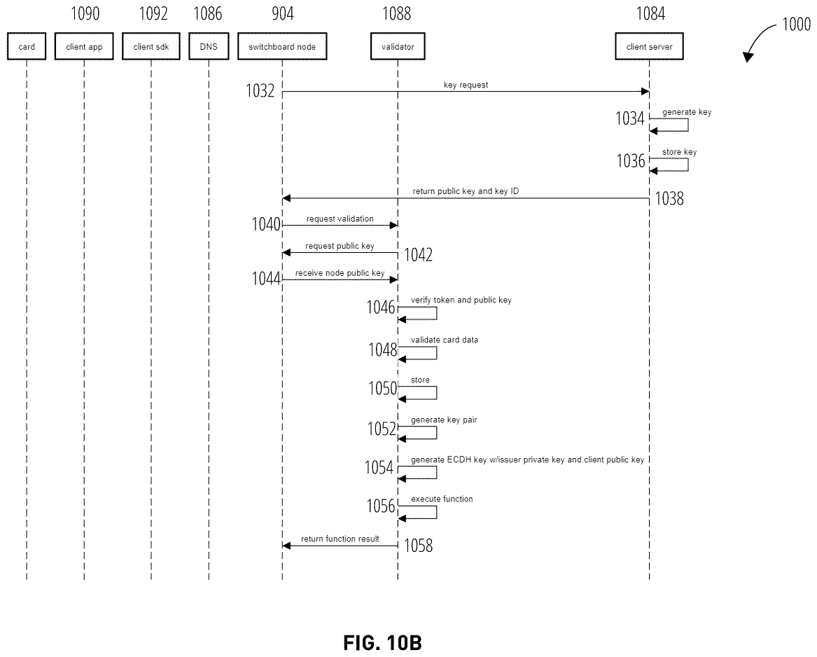

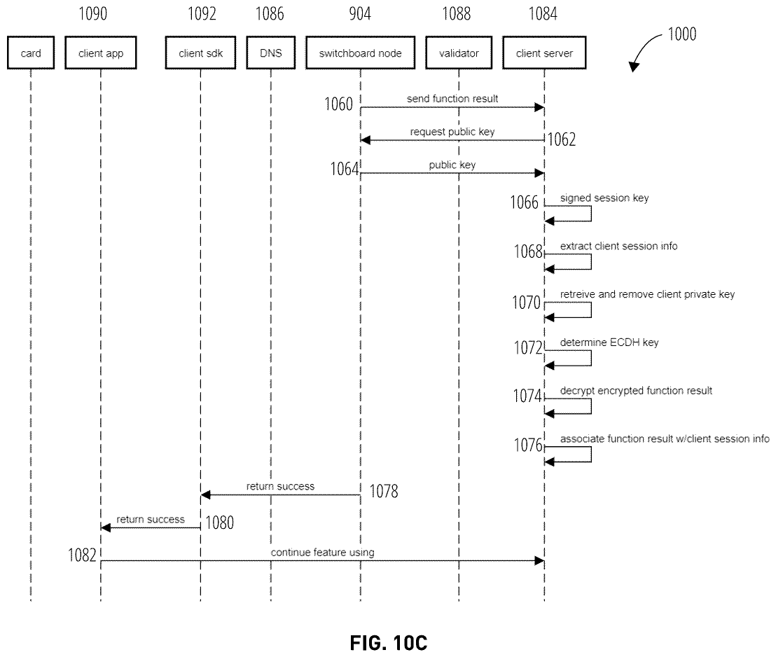

FIG. 10A-FIG. 10C illustrate an example sequence 1000 to perform operations between a contactless card 1050 and services provided by a card issuer and/or bank or similar facility with access control system 102. The illustrated sequence 1000 includes actions and communications performed by first contactless card 112a or second contactless card 112b, a client 936 including a client app 1090 and a client SDK 1092, a DNS 1086, a switchboard system including one or more nodes 904, a partner services 932 including a merchant and/or validator 1088, and control services 934 including a client server 1084 or system. In embodiments, the client app 1090 may be any application configured to execute on a client 936, such as a banking app, a merchant app, a social media app, a travel app, a gaming app, a productivity app, an entertainment app, and so forth. In embodiments, the client app 1090 includes a web browser to provide websites and pages. The client app 1090 may include and/or utilize the client SDK 1092, which may be a set of instructions that enable the client app 1090 to communicate with other components of the switchboard system.

In embodiments, at 1002 the client 936 including the client app may send a request and establish a session with a client server 1084 such that a result may be associated with the correct client device or user. The request establishes a relationship between the client device and client server, which may be an issuer server. At 1004, the client server 1084 generates a session and CLIENT SESSION INFORMATION. At 1006, the client server 1084 returns the session information, e.g., the CLIENT SESSION INFORMATION. In embodiments, the CLIENT SESSION INFORMATION may be the Client implementation-specific user session identification information.

At 1008, the client 936 may initiate a contactless card authentication process with the client 936. For example, the client 936 may call a function and/or pass information to the client 936 to initiate authentication via a contactless card 1050. At 1010-1014, the client 936 may utilize DNS to identify a node and establish communication with the node. Specifically, at 1010, the client 936 including the client SDK 1092 may send a request for switchboard hostnames, and at 1012 the DNS 1086 may return information including one or more hostnames. At 1014, the client 936 may determine a switchboard node to communicate. FIG. 9 illustrates an example of a more detailed sequence of the process to establish communication with a switchboard node.

At 1016, the client 936 may send a request for a session to the switchboard system 108. In embodiments, the request for a session may be for a function request in the format <FUNCTION REQUEST>. In embodiments, the FUNCTION REQUEST may be the data/function that the client would like to request once a contactless card 1050 has been validated. The function could be for any service discussed herein, e.g., authenticate the user, perform a transaction, request autofill data, etc. At 1018, a switchboard node 904 of the switchboard system 900, may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 1050. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card 1050 tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard node 904 private key. The switchboard node 904 may include a NODE PUBLIC/PRIVATE KEY, which is a keypair used to sign and validate JWTs.

At 1020, the switchboard node 904 may return session information to the client 936. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1022, the client SDK 1092 may determine and/or receive user consent to the terms of service. In one example, the client SDK 1092 captures and records the user consent to <FUNCTION TOS> on <CONSENT DATE> with <TOS VERSION>. The CONSENT DATE may be the timestamp for the user's consent to the TOS.

At 1024, the client 936 exchanges one or more messages with a contactless card 1050. In one example, the exchange may be based on the contactless card 1050 being tapped to a client device. In embodiments, the client SDK 1092 may provide data to the contactless card 1050 to use during the session to perform the function. The data may be provided to the contactless card 1050 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . 0E | NONCE | 8 bytes of ASCII HEX encoded 4 bytes |
| | | binary data |
| 0F . . . 12 | Session Indicators | 4 bytes of ASCII HEX encoded 2 bytes |
| | | binary data |
| 13 . . . 16 | Control Indicators | 4 bytes of ASCII HEX encoded 2 bytes |
| | | binary data |
| 17 . . . 26 | Update Date | 16 bytes of ASCII HEX encoded 8 bytes |
| | creation Time | binary data - represents 64 bit unix |
| | | timestamp |
| 27 . . . 36 | Update MAC | MAC to protect control indicators - 16 |
| | | bytes of ASCII HEX encoded 8 bytes |
| | | binary data |

The updated MAC may be calculated to protect the control indicators in embodiments. Specifically, The MAC M is determined by calculating a MAC over the 10 bytes of the update data U with the Update MAC Card Key (MCK).

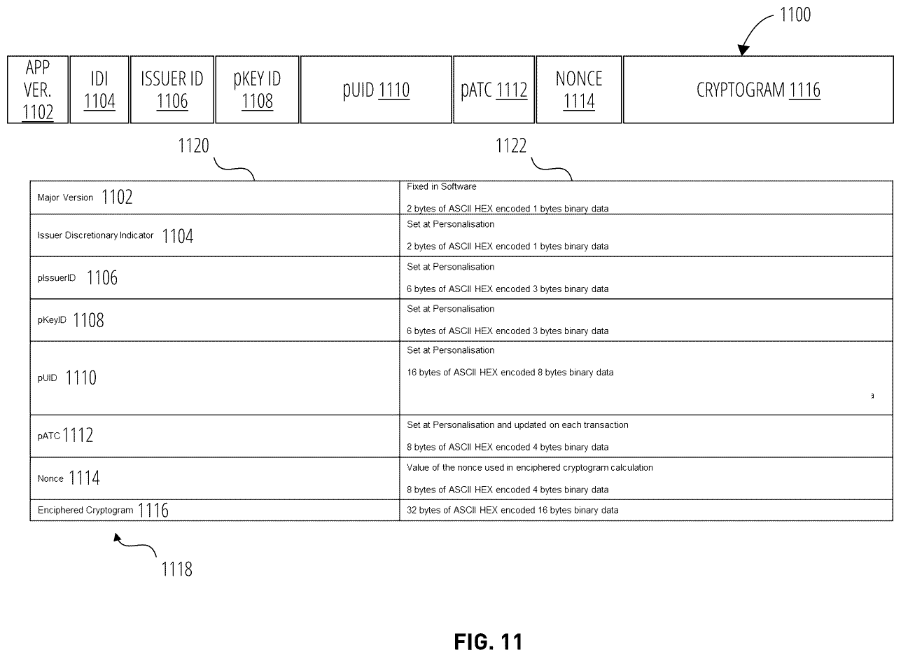

At 1024, the contactless card 1050 may generate and provide a message to the client's device including the client SDK 1092 The data in the message may be utilized by the system discussed herein to perform the function requested. One example of the message is illustrated and discussed in FIG. 11, message 1100.

At 1026, the client including the client SDK 1092 may send a message and information to the switchboard node 904. The message may be the message received from the contactless card 1050, e.g., message 1100. In addition, the client SDK 1092 may send the consent date, the TOS version, and the signed session token to the switchboard node 904. The switchboard node 904 may utilize the information to ensure the session is valid. At 1028, the switchboard node 904 verifies the signed session token is valid, e.g., is the previously provided signed session token and includes the nonce previously generated and is in the message.

In some embodiments, the switchboard node 904 is configured to determine which issuer system or client-server it should route the message to for processing. At 1030, the switchboard node 904 may determine the issuer ID by extracting it from the message received from the contactless card 1050 via the client SDK 1092. As mentioned, the issuer ID identifies the issuer of the contactless card 1050.

As shown in FIG. 10B, in embodiments, the switchboard node 904 from FIG. 9 is configured to generate and communicate secure communications with the issuer system, e.g., the client server 1084 and the validator 1088. At 1032, the switchboard node 904 sends a request for a key to the client server 1084. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1034, the client server 1084 generates a portion of the key. In some instances, the client server 1084 may generate half of the ECDH key for encryption/decryption of PII. Specifically, the client server 1084 may generate <CLIENT EC PUBLIC KEY> and <CLIENT EC PRIVATE KEY>using Elliptic Curve P256. The CLIENT EC PUBLIC KEY AND CLIENT EC PRIVATE KEY is the first half of the ECDH key negotiation.

At 1036, the client-server 1084 stores the generated portion of the key in storage. Specifically, the client server 1084 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1084 may return the public key portion to the switchboard node 904 with the KEY ID at 1038. The switchboard system 108 may store the public key portion with the KEY ID for later use, e.g., generation of the ECDH key. At 1040, the switchboard node 904 may request a validation to be performed by the validator 1088. In one example, the switchboard node 904 may send a request validation as Request validation <MESSAGE>, <SIGNED SESSION TOKEN>, <CLIENT EC PUBLIC KEY>, <CONSENT DATE>, and the <TOS VERSION>. The validator 1088 may make an out-of-band request back to the switchboard system 108 for the public key to verify the session at 1042. At 1044, the switchboard node 904 may provide the node's public key, i.e., <NODE PUBLIC KEY>. Further at 446, the 488 may utilize the node's public key to verify the secure session token.

In embodiments, the validator 1088 may validate the message at 1048. In embodiments, the validator 1088 may perform a number of validations including ensuring the nonce in the message is correct along with additional information, such as the card's unique identifier (pUID), and the counter value (pATC).

At 1050, the validator 1088 may store information associated with the session. For example, validator 1088 may store the <CONSENT DATE> with the <TOS VERSION> and the <PUID>. The validator 1088 may also generate another portion of the key, e.g., the ECDH key. For example, the validator 1088 may Generate <ISSUER EC PUBLIC KEY> and <ISSUER EC PRIVATE KEY>using Elliptic Curve P256. The ISSUER EC PUBLIC KEY and ISSUER EC PRIVATE KEY may be the second half of the ECDH key negotiation.

At 1054, the validator 1088 may generate the complete ECDH key. For example, the validator 1088 generates the <ECDH KEY> from <ISSUER EC PRIVATE KEY> and <CLIENT EC PUBLIC KEY>. The ECDH KEY is the final key generated using ECDH key negotiation.

The validator 1088 may utilize the ECDH KEY to encrypt data for the function. For example, if the validator 1088 validates the message in some instances, the validator 1088 may execute a function request to create a function result and encrypt the result with the ECDH KEY at 456. For example, the validator 1088 may Execute <FUNCTION REQUEST> to create <FUNCTION RESULT> and encrypt it with the <ECDH KEY>. The function result may be any result based on the requested function, e.g., verification of the card.

At 1058, the validator 1088 may return the function result to the switchboard node 904. In some instances, the function result is returned encrypted. For example, the validator 1088 may return the <ENCRYPTED FUNCTION RESULT> and the <ISSUER EC PUBLIC KEY>.

As shown in FIG. 10C, in embodiments, the switchboard node 904 sends the function result to the client server 1084 to process the result. In one example, the switchboard node 904 may send the <ENCRYPTED FUNCTION RESULT>, <KEY ID>, <ISSUER EC PUBLIC KEY>, and <SIGNED SESSION TOKEN>. At 1062 and 1064, the client server 1084 may make a request for and receive the public key from the switchboard node 904. In some instances, the exchange may be performed via out-of-band communication channels. The public key for the node may be <NODE PUBLIC KEY>. The public key may be used to verify the sender of the function result, etc. At 1066, the 1084 may verify the signed session key with the node's public key <NODE PUBLIC KEY> to verify the sender of the information. At 1068, the client server 1084 may extract client information from the signed session token. For example, the client server 1084 may Extract <CLIENT SESSION INFO> from <SIGNED SESSION TOKEN>, i.e., extracting the client implementation-specific user session identification information.

Further, at 1070, the client server 1084 may retrieve the client's private key with the KEY ID. Specifically, the client server 1084 may get and remove the <CLIENT PRIVATE KEY> from cache using the <KEY ID>. At 1072, the client server 1084 may generate or compute the ECDH key. For example, the client server 1084 may compute the <ECDH KEY> with the <CLIENT PRIVATE KEY>+<ISSUER EC PUBLIC KEY>. The client server 1084 may decrypt the function result with the computed key at 1074. Specifically, the client server 1084 may decrypt the <ENCRYPTED FUNCTION RESULT> with the <ECDH KEY> to determine the <FUNCTION RESULT>. At 1076, the client server 1084 associates the function result with the session.

In embodiments, the switchboard node 904 may return whether the function result was successfully completed or not at 1078 to the client SDK 1092. Further at 1080, the client SDK 1092 may notify the client app 1090 of the result. At 1082, the client app 1090 may utilize the feature. For example, the 1082 may communicate with the client server 1084 to continue the feature using the <CLIENT SESSION INFO> to fetch the redacted <FUNCTION RESULT>.

FIG. 11 illustrates an example of a message 1100 that may include the encrypted data described herein and be communicated by a contactless card to perform the functions described herein, such as those discussed in FIG. 1-4 or FIG. 10A through FIG. 10C. One or more of the fields in message 1100 may also be utilized to route the message 1100 through the switchboard system and perform authentication/validation techniques.

In embodiments, the message 1100 includes an applet version 1102 field, an issuer discretionary indicator 1104 field, an Issuer Identifier 1106 field, a pKey ID 1108 field, a pUID 1110 field, a pATC 1112 field, a nonce 1114 field, and an encrypted cryptogram 1116.

In embodiments, the fields may be in plain text or encrypted. For example, the applet version 1102 field may include an applet version in plain text. The applet version indicates which applet version is installed on a contactless card and may be used by the other systems to determine how to process the message 1100 when communicated. For example, different Applet versions require different validation logic, e.g., an older message may be routed through the issuer system to perform various operations for validation, while a newer message may be routed through the switchboard system to perform the various operations, including validation.

In embodiments, the message 1100 includes an issuer discretionary indicator 1104 field that may include issuer data and set at the time of personalization. In addition, the message 1100 includes an Issuer Identifier 1106 field that may include a unique ID assigned to the entity issuing the card, e.g., the issuer. For example, when joining the system, each issuer may be assigned a unique identifier during an onboarding operation. The issuer ID can be used by the switchboard system 900 to route a message and its contents to the appropriate services that are associated with that particular issuer.

In embodiments, the message 1100 includes a pKey ID 1108 field. In some instances, the pKey ID 1108 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 500 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described below.

The message 1100 may include a pUID 1110 field, including a card unique identifier assigned to the contactless card at personalization time. The pUID 1110 field data may be a combination of alphanumeric characters used to identify each card and associated with a user uniquely.

In embodiments, the message 1100 includes a pATC 1112 field configured to hold a counter value. The counter value keeps a count of reads (taps) made on the contactless card in a hexadecimal format in one example. Further, a counter value may generate session keys to encrypt at least a portion of a message.

In embodiments, each time a message 1100 is created, a new session key is derived and utilized to generate one or more portions of the message 1100. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1100 is static and set on the card during personalization, and other data is dynamic and may be generated by the card during an operation, e.g., when a read operation is being performed. Note that in some instances, the static information may be updateable, but it umay require the customer and card to go through a secure update process, which may be controlled by the issuer.

In embodiments, the contactless card 500 may communicate a message between a device, such as a mobile device, during a read operation. For example, in response to the contactless card 500 being tapped onto a surface of the device, e.g., brought within wireless communication range, a read operation may be performed on the contactless card 500, and the contactless card 500 may generate and provide the message to the device. For example, once within range, the contactless card 500 and the device may perform one or more exchanges for the contactless card 500 to send the message to the device.

The wireless communication may be in accordance with a wireless protocol, such as near-field communication (NFC), Bluetooth, WiFi, and the like. In some instances, a message may be communicated between a contactless card 500 and a device via wired means, e.g., via the contact pad, and in accordance with the EMV protocol.

As discussed above, the contactless card 500 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card stores the generated application key(s) or UDK(s).

In embodiments, the contactless card utilizes the application key(s) or UDK(s) to generate session keys for each encrypted data is generated. The following is one processing flow that may be performed by the contactless to generate a unique cryptogram session key (ASK).

To generate the ASK, the contactless card computes SKL by encrypting [ATC [2] ∥ ATC [3] ∥ ‘F0’ ∥ ‘00’ ∥ [ATC [0] ∥ [ATC [1] ∥ [ATC [2] ∥ [ATC [3]] with an application key. Further, the contactless card computes SKR by encrypting [ATC [2] ∥ ATC [3] ∥ ‘0F’ ∥ ‘00’ ∥ [ATC [0] ∥ [ATC [1] ∥ [ATC [2] ∥ [ATC [3] with the application key. Finally, the contactless card concatenates SKL with SKR to form an authentication session key (ASK). In embodiments, the ASK is used to perform operations utilizing the contactless card, such as encrypting the cryptographic MAC.

In embodiments, the contactless card also supports session key derivation to generate a unique encipherment session key DESK. The contactless card computes an SKL by encrypting [ATC [2] ∥ ATC [3] ∥ ‘F0’ ∥ ‘00’ ∥ ‘00’ ∥ ‘00’ ∥ ‘00’ ∥ ‘00’] with a Data Encryption Key (DEK) or UDK. Further, the contactless card computes SKR by encrypting [ATC [2] ∥ ATC [3] ∥ ‘0F’ ∥ ‘00’ ∥ ‘00 ∥ ‘00’ ∥ ‘00’ ∥ ‘00’] with the DEK or UDK. The contactless card concatenates SKL with SKR to form the Data Encipherment Session Key (DESK).

In embodiments, the contactless card generates encrypted data or a cryptogram utilizing the session keys. Specifically, the contactless card generates a cryptogram C by calculating a MAC over the 32-byte transaction data T using the Authentication Session Key (ASK).

The contactless card may process the data to generate the cryptogram. Specifically, the contactless card divides T into four blocks of 8 bytes of data: T=T1 ∥ T2 ∥ T3 ∥ T4. The contactless card computes B=DES(ASKL) [T1], where is the Data Encryption Standard or another symmetric encryption algorithm, ASKL is a portion of the ASK, e.g., the “left” half of the key. The contactless card computes B=[B XOR T2], and, the contactless card computes B=DES(ASKL) [B], where DES is an encryption algorithm. The contactless card computes B=[B XOR T3], and the contactless card computes B=DES(ASKL) [B]. The contactless card computes B=[B XOR T4], and the contactless card computes B=DES(ASKL) [B]. The contactless card computes B=DES⁻¹(ASKR) [B], where DES⁻¹ is the reciprocal DES operation, and ASKR is a portion of the ASK, e.g., the right half. The contactless card computes the cryptogram C=DES(ASKL) [B].

In embodiments, a contactless card may also encipher the cryptogram to secure the data further. For example, a contactless card may generate an 8-byte random number [RND] and the card computes E1=DES3(DESK) [RND], where DES3 is a symmetric encryption algorithm such as the Triple Data Encryption Standard. The contactless card then computes B=[E1] XOR [C], where C is the cryptogram generated, as discussed above. The contactless card computes E2=DES3(DESK) [B], where B is computed above. Further, the contactless card generates the 16-byte enciphered payload E=[E1] ∥ [E2].

In embodiments, a device or the contactless card may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes) ∥ Update Date Time (8 bytes) ∥ ‘80’ ∥ ‘00 00 00 00 00’]. For the calculations, the data may be divided into two separate portions. Specifically, the data U is broken into two blocks of 8 bytes of data, where U=U₁ ∥ U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

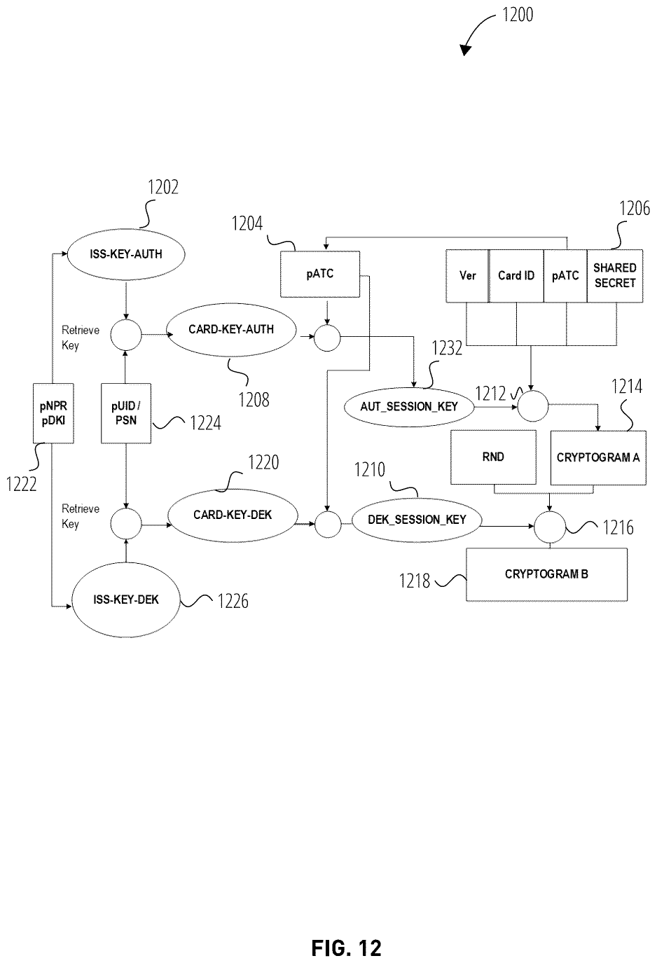

FIG. 12 illustrates a diagram of a system 1200 configured to implement one or more embodiments of the present disclosure. FIG. 12 provides one example system 1200 for generating the encrypted data and authorization code described above. As explained below, during the contactless card creation process (also referred to as personalization), two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 1202, 1226 may be required for each part of the portfolio on which the one or more applets is issued. For example, the first master key 1202 may comprise an Issuer Cryptogram Generation/Authentication Key (Iss-Key-Auth) and the second master key 1226 may comprise an Issuer Data Encryption Key (Iss-Key-DEK). As further explained herein, two issuer master keys 1202, 1226 are diversified into card master keys 1208, 1220, which are unique for each card. In some examples, a network profile record ID (pNPR) 1222 and derivation key index (pDKI), as back office data, may be used to identify which Issuer Master Keys 1202, 1226 to use in the cryptographic processes for authentication. The system performing the authentication may be configured to retrieve values of pNPR 1222 and pDKI for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1208 and Card-Key-Dek 1220). The session keys (Aut-Session-Key 1232 and DEK-Session-Key 1210) may be generated by the one or more applets and derived by using the application transaction counter (pATC) 1204 with one or more algorithms. To fit data into the one or more algorithms, only the 2 low order bytes of the 4-byte pATC 1204 is used. In some examples, the four byte session key derivation method may comprise: F1:=PATC (lower 2 bytes) ∥ ‘F0’ ∥ ‘00’ ∥ PATC (four bytes) F1: =PATC (lower 2 bytes) ∥ ‘0F’ ∥ ‘00’ ∥ PATC (four bytes) SK: ={(ALG (MK) [F1]) ∥ ALG (MK) [F2]}, where ALG may include 3DES ECB and MK may include the card unique derived master key.

As described herein, one or more MAC session keys may be derived using the lower two bytes of pATC 1204 counter. At each tap of the contactless card, pATC 1204 is configured to be updated, and the card master keys Card-Key-AUTH 1208 and Card-Key-DEK 1220 are further diversified into the session keys Aut-Session-Key 1232 and DEK-Session-KEY 1210. pATC 1204 may be initialized to zero at personalization or applet initialization time. In some examples, the pATC counter 1204 may be initialized at or before personalization, and may be configured to increment by one at each NDEF read.

Further, the update for each card may be unique, and assigned either by personalization, or algorithmically assigned by pUID 1224 or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1232. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1232, as explained above. As explained above, the low order two bytes of the counter may be used to diversify for the one or more MAC session keys. As explained below, AUT-Session-Key 1232 may be used to MAC data 1206, and the resulting data or cryptogram A 1214 and random number RND may be encrypted using DEK-Session-Key 1210 to create cryptogram B or output 1218 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1210 derived from the Card-Key-DEK 1220. In this case, the ATC value for the session key derivation is the least significant byte of the counter pATC 1204.

The format below represents a binary version example embodiment. Further, in some examples, the first byte may be set to ASCII ‘A’.

| Message Format | | | | |
|---|---|---|---|---|
| 1 | 2 | 4 | 8 | 8 |
| 0x43 (Message Type ‘A’) | Version | pATC | RND | Cryptogram A (MAC) |
| Cryptogram A (MAC) | 8 bytes | | | |
| Mac of | | | | |

| 2 | 8 | 4 | 4 | 18 bytes input data |
|---|---|---|---|---|
| Version | pUID | pATC | Shared Secret | |

| Message Format | | | | | |
|---|---|---|---|---|---|
| 1 | 2 | 4 | | 16 | |
| 0x43 (Message Type ‘A’) | Version | pATC | | Cryptogram B | |
| Cryptogram A (MAC) | 8 bytes | | | | |
| MAC of | | | | | |
| 2 | 8 | 4 | 4 | | 18 bytes input data |
| Version | pUID | pATC | Shared Secret | | |
| Cryptogram B | 16 | | | | |
| Sym Encryption of | | | | | |
| 8 | 8 | | | | |
| RND | Cryptogram A | | | | |

Another exemplary format is shown below. In this example, the tag may be encoded in hexadecimal format.

| Message Format | | | | |
|---|---|---|---|---|
| 2 | 8 | 4 | 8 | 8 |
| Version | pUID | pATC | RND | Cryptogram A (MAC) |
| 8 bytes | | | | |

| 8 | 8 | 4 | 4 | 18 bytes input data |
|---|---|---|---|---|
| pUID | pUID | pATC | Shared Secret | |

| Message Format | | | | | |
|---|---|---|---|---|---|
| 2 | 8 | 4 | | 16 | |
| Version | pUID | pATC | | Cryptogram B | |
| 8 bytes | | | | | |
| 8 | | 4 | 4 | | 18 bytes input data |
| pUID | pUID | pATC | Shared Secret | | |
| Cryptogram B | 16 | | | | |
| Sym Encryption of | | | | | |
| 8 | 8 | | | | |
| RND | Cryptogram A | | | | |

The UID field of the received message may be extracted to derive, from master keys Iss-Key-AUTH 1202 and Iss-Key-DEK 1226, the card master keys (Card-Key-Auth 1208 and Card-Key-DEK 1220) for that particular card. Using the card master keys (Card-Key-Auth 508 and Card-Key-DEK 1220), the counter (pATC) field of the received message may be used to derive the session keys (Aut-Session-Key 1232 and DEK-Session-Key 1210) for that particular card. Cryptogram B 1218 may be decrypted using the DEK-Session-KEY, which yields cryptogram A 1214 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 1214, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1232. The input data 1206 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1212, data 1206 is processed through the MAC using Aut-Session-Key 1232 to produce MAC output (cryptogram A) 1214, which is encrypted.

In order to provide additional protection against brute force attacks exposing the keys on the card, it is desirable that the MAC cryptogram A 1214 be enciphered. In some examples, data or cryptogram A 1214 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1210. In the encryption operation 1216, data or cryptogram A 1214 and RND are processed using DEK-Session-Key 1210 to produce encrypted data, cryptogram B 1218. The data 1214 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

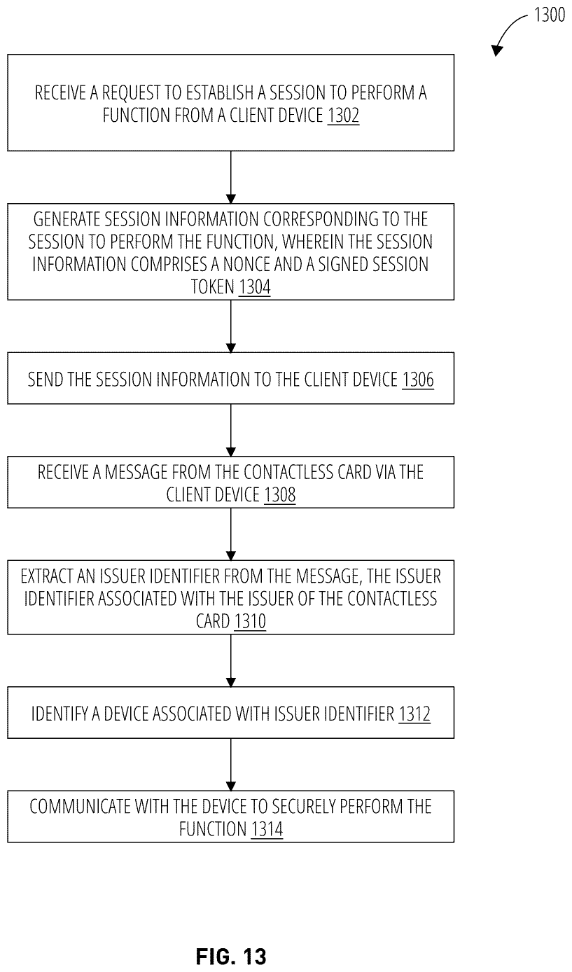

FIG. 13 illustrates an example of routine 1300 in accordance with embodiments discussed herein. The routine 1300 may be executed, for example, in response to users attempting to access the area 118 of FIG. 1. In block 1302, the routine 1300 includes receiving, by a node in a system, a request to establish a session to perform a function from a client device, wherein the function is at least partially performed utilizing a contactless card. The function may be, for example, altering the state of the locking mechanism 104 to allow access to the area 118. In some instances, the node may be one of a plurality nodes of a switchboard system. The node may be previously selected by the sending device via a DNS operation performed.

In block 1304, the routine 1300 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1306, routine 1300 includes sending the session information to the client device by the node. The client device may communicate with a contactless card to receive data, for example, the encrypted data described above, from the card to authenticate and perform a function, such as altering the state of the locking mechanism 104 in FIG. 1. In some instances, the client device, such as the access control system 102 or the mobile device 302 may send the nonce from the node to the contactless card. The contactless card may utilize the nonce when generating the message to communicate back to the client device. Finally, the node, e.g., incorporates it into a cryptographic portion of the message (see FIG. 11).

In block 1308, routine 1300 includes receiving, by the node, a message from the contactless card via the client device. The message or encrypted data may be generated by the contactless card. FIG. 11 illustrates one example of a message 1100 or encrypted data. In some embodiments, the node verifies the message. For example, the node may verify a nonce in the message and a signed session token.

In block 1310, routine 1300 extracts an issuer identifier from the message by the node, the issuer identifier associated with the issuer of the contactless card. In some instances, the issuer identifier may be in a plaintext format.

In block 1312, routine 1300 identifies, by the node, a device associated with the issuer identifier. For example, the node may perform a lookup to determine a server associated with the issuer identifier and the function to be performed.

In block 1314, routine 1300 communicates, by the node, with the device to securely perform the function.

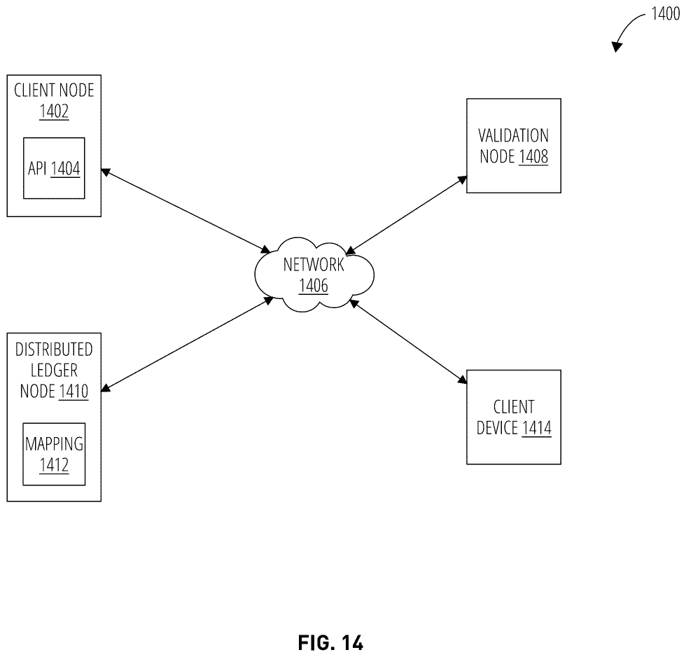

FIG. 14 illustrates a distributed network authentication system 1400 according to an example embodiment. As further discussed below, system 1400 can include client node 1402, API 1404, network 1406, distributed ledger node 1410, mapping 1412, and client device 1414. Although FIG. 14 illustrates single instances of the components, system 1400 can include any number of components.

System 1400 can include a client node 1402, which can be a network-enabled computer as described herein. In some examples, client node 1402 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, client node 1402 can execute one or more applications, such as software applications, that enable, for example, network communications with one or more components of system 1400, transmit and/or receive data, and perform the functions and processes described herein.

The client node can contain an API 1404. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1404 to interact with the service, such as by performing a remote call to an API for interacting with a web-based service.

API 1404 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1402 can communicate with one or more other components of system 1400 either directly or via network 1406. Network 1406 can comprise one or more of a wireless network, a wired network or any combination of wireless network and wired network, and may be configured to connect the components of system 1400. While FIG. 14 illustrates communication between the components of system 1400 through network 1406, it is understood that any component of system 1400 can communicate directly with another component of system 1400, e.g., without involving network 1406.

System 1400 can include a validation node 1408, which can be a network-enabled computer as described herein. In some examples, validation node 1408 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, validation node 1408 can execute one or more applications, such as software applications, that enable, for example, network communications with one or more components of system 1400, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1400 can include a distributed ledger node 1410, which can be a network-enabled computer as described herein. In some examples, distributed ledger node 1410 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400.

In some examples, distributed ledger node 1410 can execute one or more applications, such as software applications, that enable, for example, network communications with one or more components of system 1400, transmit and/or receive data, and perform the functions and processes described herein.

Distributed ledger node 1410 can contain a mapping 1412. In some examples, mapping 1412 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1400, or the one or more databases can be hosted externally to any component of the system 1400. In some examples, the one or more databases can be contained in the distributed ledger node 1410, and in other examples the one or more databases can be stored outside of distributed edger node 1410 but in data communication with distributed ledger node 1410. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1410. In other examples, the one or more databases can be remote from distributed ledger node 1410 but in data communication with distributed ledger node 1410. Data communication between the one or more databases and distributed ledger node 1410 can be a direct data communication or data communication via a network, such as the network 1406.

In some examples, client node 1402 can be in data communication with distributed ledger node 1410. Distributed ledger node 1410 can contain mapping 1412. Mapping 1414 may include, e.g., a mapping between a validation node address and the validation node 1408, a mapping between a routing number and a validation node address, and/or a mapping between a routing number and validation node 1408. In some examples, mapping 1412 can include a digital signature associated with an entity having permission to validate for a routing number. Based on one or more of these associations, client node 1402 can call validation node for validation and/or provide direction to the client device to reach the appropriate validation node. This can be accomplished by calling a validation API associated with validation node 1408.

In some examples, iterations of the mappings described herein, such as mapping 1412, can also include a software or applet version number. The version number can be used to identify a validation node or validation node address or choose between multiple validation addresses for one validation node.

In some examples, client node 1402 and distributed ledger node 1410 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1410 can update mapping 1412 to reflect a different association between, e.g., a routing number, a validation node address, and a validation node. In some examples, degrees of permissions can be issued. For example, if client node 1402 were to function to route data to validation node 1408 (or other validation nodes), client node 1402 can be given a certain level of permissions. As another example, if distributed ledger node 1410 were to have the capability to update mapping 1412, distributed ledger node 1410 can have a different, higher level of permissions.

System 1400 can include a client device 1414, which can be a network-enabled computer as described herein. In some examples, distributed ledger node 1414 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1400. Client device 1414 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1414 can be in data communication with another network-enabled computer not shown in FIG. 14, such as a smart card (e.g., a contactless card or a contact-based card).

In some examples, client device 1414 can execute one or more applications, such as software applications, that enable, for example, network communications with one or more components of system 1400, transmit and/or receive data, and perform the functions and processes described herein.

In some examples, upon receipt of an authentication request, client device 1414 can call (e.g., via an API) client node 1402. The call can include a routing number and/or an applet or software version number, and client node 1402 can query distributed ledger node 1410 and mapping 1412. Once the query returns the identification of a validation node (e.g., validation node 1408) and/or a validation node address associated with that routing number and/or applet or software version, client node 1402 can reply to client device 1414. Client device 1414 can then proceed with authentication with the validation node. The authentication can be performed by, e.g., the systems and methods described herein, such as by the generation, encryption, transmission, decryption, and validation of a cryptogram as described herein.

In some examples, client node 1402 can be co-resident with validation node 1408. In these examples, client node 1402 can handle the authentication in a single call from client device 1414. In some examples, this can be acceptable only if it is permissible for the full authentication transmission (e.g., a cryptogram as described herein) to be sent to client nodes that are not involved in authentication.

In some examples, if client node 1402 receives, from client device 1414, a routing number that is not handled by its location, client node 1402 can return a code indicating that this routing number is not handled, along with validation node address for the responsible validation node. Client device 1414 can then send the full authentication transmission to validation node 1408 using the received validation node address.

In some examples, client node 1402 can enter the distributed network with different permissions. For example, client node 1402 can be a read-only router of data. As another example, client node 1402 can have permission to send messages to distributed ledger node 1410 updating one or more routing paths for one or more routing numbers. However, client node 1402 would be prevented from updating one or more routing paths for one or more routing numbers for other entities that control other routing numbers which are not associated with client node 1402 or that did not grant this permission. As another example, distributed ledger node 1410 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1402, distributed ledger node 1410, and/or validation node 1408, if security, legal, and/or financial conditions are met, however, delegation is not required.

In some examples, one or more APIs can facilitate communication between components of system 1400 via network 1406. In other examples, one or more APIs are not required. Rather, the components of system 1400 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1408 for authentication, can require storage of the keys in one or more HSMs, to promote key security and ensure that the keys are never entered into memory.

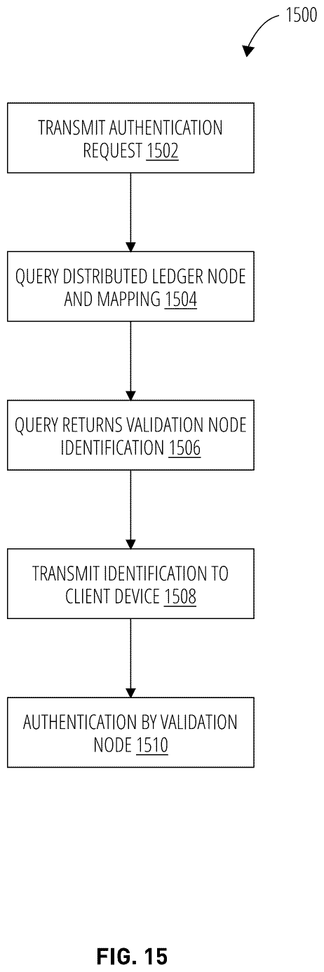

FIG. 15 illustrates a method 1500 performed by a distributed network authentication system according to an example embodiment. Such a distributed network authentication system can perform authentication services such as verifying the identity of a user account associated with the contactless card 500 described herein. For example, the method 1500 can be performed by distributed network authentication system 1400 and or by another distributed network authentication system.

In block 1502, a client device can transmit an authentication request to a client node. The authentication request can include, without limitation, a routing number, a software version number, and/or an applet version number. The request can be made by an API call or other communication between the client device and the client node.

In block 1504, after receiving the authentication request, the client node can transmit a query (e.g., via an API call) to a distributed ledger node. The distributed ledger node contain a mapping, and the distributed ledger node can submit the query to the mapping.

In block 1506, the query can return an identification of a validation node and/or a validation node address, and the distributed ledger node can transmit this identification to the client node.

In block 1508, the client node can transmit the identification to the client device. After receiving the identification, the client device can proceed with authentication with the identified validation node and/or validation node address, in block 1510.

The various elements of the devices as previously described with reference to FIGS. 1-15 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
receiving, at an authentication server, first encrypted data from a first contactless card associated with a first user account and second encrypted data from a second contactless card associated with a second user account;
determining, by the authentication server and based on the first encrypted data and the second encrypted data, whether the first user account and the second user account are authorized to alter a state of an access control system; and
in response to both the first user account and the second user account being authorized, causing, by the authentication server, a signal to be sent to the access control system to alter the state thereof.

2. The method of claim 1, wherein receiving the first encrypted data and the second encrypted data includes receiving, by the authentication server, the first encrypted data via a contactless card reader proximate to the access control system.

3. The method of claim 2, further comprising receiving the first encrypted data and the second encrypted data via a routing network connected between the authentication server and the contactless card reader.

4. The method of claim 3, wherein the first encrypted data and the second encrypted data are received sequentially by the contactless card reader.

5. The method of claim 1, further comprising:
deriving, by the authentication server using a first counter included in the first encrypted data, a first decryption key to decrypt the first encrypted data;
deriving, by the authentication server using a second counter included in the second encrypted data, a second decryption key to decrypt the second encrypted data;
decrypting, by the authentication server using, respectively, the first decryption key and second decryption key, the first encrypted data and the second encrypted data to obtain first decrypted data and second decrypted data, respectively;
comparing, by the authentication server, the first decrypted data and second decrypted data to a list of authorized user accounts and corresponding expected decrypted data; and
determining, by the authentication server, that the first decrypted data matches a corresponding first expected decrypted data for the first user account and determining, by the authentication server, that the second decrypted data matches a corresponding second expected decrypted data for the second user account.

6. The method of claim 5, further comprising:
in response to the authentication server determining that the first decrypted data matches the corresponding first expected decrypted data, sending a first portion of a Shannon-Secret-Sharing key to the access control system as part of the signal; and
in response to the authentication server determining that the second decrypted data matches the corresponding second expected decrypted data, sending a second portion of the Shannon-Secret-Sharing key to the access control system as part of the signal;
wherein the first portion of the Shannon-Secret-Sharing key and the second portion of the Shannon-Secret-Sharing key are to be used by the access control system to alter the state thereof.

7. The method of claim 1, wherein altering the state of the access control system includes altering a locked state of a locking mechanism of one or more of the following: a bank vault, a branch access door, and a teller's drawer.

8. An access control system comprising:
a locking mechanism to prevent physical access to an area;
a memory for storing executable instructions;
a processing circuit in communication with the locking mechanism, the processing circuit to execute the executable instructions, which when executed cause the processing circuit to:
receive first encrypted data associated with a first user account and second encrypted data associated with a second user account;
send the first encrypted data and the second encrypted data to an authentication server to determine whether the first user account and the second user account are authorized to alter a state of the locking mechanism;
in response to receiving, from the authentication server, an indication that the first user account and the second user account are authorized, send a control signal to the locking mechanism to alter the state thereof to thereby allow or prevent access to the area.

9. The access control system of claim 8, further comprising one or more contactless card readers in communication with the processing circuit;
wherein the first encrypted data and the second encrypted data are received via the one or more contactless card readers.

10. The access control system of claim 9, wherein the processing circuit is to send the first encrypted data and the second encrypted data through a routing network to the authentication server.

11. The access control system of claim 8, wherein the first encrypted data is received from a first contactless card associated with the first user account and the second encrypted data is received from a second contactless card associated with the second user account.

12. The access control system of claim 8, wherein the indication that the first user account and the second user account are authorized includes a first portion of a Shannon-Secret-Sharing key and a second portion of the Shannon-Secret-Sharing key.

13. The access control system of claim 12, wherein the processing circuitry is further to:
combine the first portion of the Shannon-Secret-Sharing key and the second portion of the Shannon-Secret-Sharing key to obtain a combined Shannon-Secret-Sharing key;
compare the combined Shannon-Secret-Sharing key to an expected Shannon-Secret-Sharing key; and
in response to the combined Shannon-Secret-Sharing key corresponding to the expected Shannon-Secret-Sharing key, send the control signal to the locking mechanism to alter the state thereof.

14. The access control system of claim 8, wherein the area includes one or more of: a bank vault, a branch room or lobby, and a teller's drawer.

15. A non-transitory computer-readable storage medium having executable instructions stored thereon, which, when executed by a processing circuit of an authentication server, cause the processing circuit to:
receive first encrypted data from a first contactless card associated with a first user account and second encrypted data from a second contactless card associated with a second user account;
determine, based on the first encrypted data and the second encrypted data, whether the first user account and the second user account are authorized to access a controlled area; and
in response to both the first user account and the second user account being authorized, cause a signal to be sent to an access control system to alter a state thereof to grant or prevent access to the controlled area.

16. The non-transitory computer-readable storage medium of claim 15, wherein the signal to be sent to the access control system is to alter a locked state of a locking mechanism that controls access to the controlled area, the controlled area including one or more of: a bank vault, a lobby or room of a bank branch, and a teller's drawer.

17. The non-transitory computer-readable storage medium of claim 16, wherein the processing circuit to receive the first encrypted data and the second encrypted data includes the processing circuit to receive the first encrypted data and the second encrypted data via one or more contactless card readers in communication with the authentication server.

18. The non-transitory computer-readable storage medium of claim 17, wherein the first encrypted data and the second encrypted data are received sequentially via the one or more contactless card readers.

19. The non-transitory computer-readable storage medium of claim 15, wherein the processing circuit is further to:
derive, using a first counter included in the first encrypted data, a first decryption key to decrypt the first encrypted data;
derive, using a second counter included in the second encrypted data, a second decryption key to decrypt the second encrypted data;
decrypt, using, respectively, the first decryption key and second decryption key, the first encrypted data and the second encrypted data, to obtain first decrypted data and second decrypted data, respectively;
compare the first decrypted data and second decrypted data to a list of authorized user accounts and corresponding expected decrypted data; and
determine that the first decrypted data matches a corresponding first expected decrypted data for the first user account and determine that the second decrypted data matches a corresponding second expected decrypted data for the second user account.

20. The non-transitory computer-readable storage medium of claim 19, wherein the processing circuit is further to:
in response to the processing circuit determining that the first decrypted data matches the corresponding first expected decrypted data, send a first portion of a Shannon-Secret-Sharing key to the access control system as part of the signal to be sent to the access control system;
in response to the authentication server determining that the second decrypted data matches the corresponding second expected decrypted data, send a second portion of the Shannon-Secret-Sharing key to the access control system as part of the signal to be sent to the access control system;
wherein the first portion of the Shannon-Secret-Sharing key and the second portion of the Shannon-Secret-Sharing key are to be used by the access control system to alter the state thereof.
